(19) United States
(12) Patent Application Publication
(10) Pub. No.: US 2022/0137491 A1
(43) Pub. Date: May 5, 2022

(54) MOBILE SMART DEVICE CASE WITH ACCESSORY INTERFACE

(71) Applicant: Moment Inc, Seattle, WA (US)

(72) Inventors: Alexander Stankie, Seattle, WA (US); Marc Barros, Seattle, WA (US); Robert John Lincoln, Seattle, WA (US); Erik Hedberg, Seattle, WA (US); Michio Papers, Seattle, WA (US); Audrey Louchart, Seattle, WA (US); Francis Choltco-Devlin, Seattle, WA (US); Spencer Smith, Seattle, WA (US)

(21) Appl. No.: 17/516,705

(22) Filed: Nov. 2, 2021

Related U.S. Application Data
(63) Continuation-in-part of application No. 17/516,685, filed on Nov. 1, 2021.
(60) Provisional application No. 63/108,429, filed on Nov. 1, 2020.
(60) Provisional application No. 63/108,280, filed on Oct. 30, 2020.

(51) Int. Cl. G03B 17/56; H04M 1/72409; G03B 30/00; F16M 11/04; F16M 11/28

(52) U.S. Cl. CPC G03B 17/561; H04M 1/724092; F16M 11/28; G03B 30/00; F16M 11/041; G03B 17/566

(57) ABSTRACT

A mobile smart device accessory interface system includes a mobile smart device case that has magnet array embedded in it that is configured for magnetically coupling with a mobile smart device accessory or with a mobile smart device accessory interface device or both. The mobile smart device accessory interface device includes a compatible magnet array configured for magnetically coupling with the magnet array of the mobile smart device case. In combination, the mobile smart device case and the mobile smart device accessory interface device provide a system for magnetically coupling a mobile smart device accessory with a mobile smart device.

### PRIORITY

This application is a continuation-in-part (CIP) of U.S. patent application Ser. No. 17/516,685, filed Nov. 1, 2021, which claims the benefit of priority to U.S. patent applications Ser. Nos. 63/108,429, filed Nov. 1, 2020 and 63/108,280, filed Oct. 30, 2020, which are each incorporated by reference.

### RELATED PATENTS AND PATENT APPLICATIONS

This United States patent application is one of three contemporaneously-filed United States patent applications by the same Applicant and Inventors that are entitled: ACCESSORY INTERFACE FOR MOBILE SMART DEVICE AND CASE, application Ser. No. 17/516,685; MOBILE SMART DEVICE CASE, application Ser. No. 17/516,694; and MOBILE SMART DEVICE CASE WITH ACCESSORY INTERFACE, application Ser. No. 17/516,705. Each of these related applications is hereby incorporated by reference.

This application is also related to several United States patents and patent applications by the same Applicant, including U.S. Pat. Nos. 11,082,596, 11,036,031, D918,284, D918,283, 10,921,687, 10,798,279, 10,795,240, 10,375,284, 10,348,946, 10,313,568, 10,038,830, 10,003,724, 9,838,581, 9,781,319, 9,729,770, 9,596,393 and 9,467,608; and U.S. patent application Ser. No. 16/924,127, filed Jul. 8, 2020. Each of these related applications is hereby incorporated by reference.

### BACKGROUND

Many photographers who use attachable/detachable auxiliary lenses quickly discover that tripod feet supplied by manufacturers of various modern cameras are simply not suitable to be mounted on regular tripod heads. It can be a rather frustrating experience trying to figure out a tripod configuration that will work well particularly when additional accessories such as auxiliary lenses, lights, microphones, and gimbals may be attached to their camera or camera-enabled smart device. Nobody wants an expensive smart device or quality lens or other accessory to end up crashing on the ground.

It is desired to be able to reliably couple display-capable and/or camera-enabled mobile smart device accessories such as tripods, cold shoes, hot shoes, and screw thread mounted accessories with smart devices and smart device cases. Such accessories may include lights, microphones, speakers, gimbals, and length and/or orientation adjustable mobile smart device positioning accessories, flexible arms and/or magic arms.

It is also desired to be able to reliably mount a smart device, with or without a smart device case, to a wall or other surface and in a car for hands-free use.

It is desired to be able to attach an iphone 12 or an iphone 13 series Apple smart phone via magsafe™ to a tripod or stand, to a cold shoe, to any accessory with a screw thread coupling interface, to a gimbal, magic arm, flexible arm, selfie stick and/or other adjustable, portable and/or handheld accessory mobile smart phone attachment interface devices, to a wall or other flat surface, and/or within a motor vehicle for hands-free use while driving.

It is also desired to be able to attach a mobile smart device that is not equipped with magsafe™ coupling capability to a mobile smart device accessory using magnetic coupling.

It is desired to be able to attach a microphone or a light to an iPhone 12 or an iphone 13 series Apple smart phone via magsafe™.

It is also desired to be able to attach a microphone or a light to a mobile smart device that is not equipped with magsafe™ coupling capability using magnetic coupling.

It is also desired to be able to attach a microphone or a light to a cold shoe mount interface while the mobile smart device is also mounted on a tripod using magnetic coupling.

It is also desired to be able to attach a mobile smart device as a display to an accessory gimbal or to a magic or flexible arm or to a wall, tripod or stand or within a car for hands-free viewing.

It is also desired to solve a problem that one currently has to attach a magnetic plate, which may be a permanent or quasi-permanent stick on magnet to the back of his or her phone to be able to couple certain accessories to the phone, such as the DJI Osmo 4 Gimbal for example as well as many other accessories that are not configured for magnetic coupling. That is, it is desired to have a magnetic adapter plate for coupling to the DJI Osmo 4 Gimbal and/or separate adapter plates and/or one or more universal or quasi-universal adapter plates for other accessories having the same issue.

To use a microphone with a smartphone, typically a clamp is used or another physical mount accessory is used to attach the microphone accessory to the smartphone. It is desired to be able to magnetically couple a microphone to a smart phone rather than using extra hardware.

To use lights with a mobile smartphone devices, typically one has to use a clamp or a rig. It is desired to be able to magnetically attach a light to a mobile smart device or case in lieu of using a clamp or rig.

### BRIEF DESCRIPTION OF THE DRAWINGS

FIGS. 1A-1G schematically illustrate accessory interface devices that are configured to magnetically couple with compatible mobile smart devices and mobile smart device cases in accordance with example embodiments.

FIG. 1B schematically illustrates a mobile smart device case that is configured to magnetically couple with compatible mobile smart device accessories and accessory interface devices in accordance with an example embodiment.

FIGS. 2A-2i schematically illustrate tripod mounting capable interface devices that are configured to magnetically couple with compatible mobile smart devices and mobile smart device cases in accordance with example embodiments.

FIGS. 2G-2i schematically illustrate mobile smart device cases that are configured to magnetically couple with compatible mobile smart device accessories and accessory interface devices in accordance with example embodiments.

FIGS. 3A-3E schematically illustrate cold shoe mounting capable interface devices that are configured to magnetically couple with compatible mobile smart devices and mobile smart device cases in accordance with example embodiments.

FIG. 3E schematically illustrates a mobile smart device case that is configured to magnetically couple with compatible mobile smart device accessories and accessory interface devices including cold shoe mounting capable interface devices in accordance with example embodiments.

FIGS. 4A-4L schematically illustrate tripod and cold shoe mounting capable combination interface devices that are configured to magnetically couple with compatible mobile smart devices and mobile smart device cases in accordance with example embodiments.

FIGS. 4H-4j schematically illustrate mobile smart device cases that are configured to magnetically couple with compatible mobile smart device accessories and accessory interface devices including tripod and cold shoe mounting capable combination interface devices in accordance with example embodiments.

FIGS. 4B-4j schematically illustrate cold shoe mounting capable interface devices that include length and orientation adjustable cold shoe arm coupling mechanisms in accordance with example embodiments.

FIGS. 4K-4L schematically illustrate tripod and cold shoe mounting capable combination interface devices that include length adjustable tripod and cold shoe mounting capable interface device arms in accordance with example embodiments.

FIGS. 5A-5F schematically illustrate universal screw thread mounting capable interface devices that are configured to magnetically couple with compatible mobile smart devices and mobile smart device cases in accordance with example embodiments.

FIG. 5F schematically illustrates a mobile smart device case that is configured to magnetically couple with compatible mobile smart device accessories and accessory interface devices including universal screw thread mounting capable interface devices in accordance with example embodiments.

FIGS. 6A-6L schematically illustrate wall or other surface mounting capable interface devices that are configured to magnetically couple with compatible mobile smart devices and mobile smart device cases in accordance with example embodiments.

FIGS. 6K-6L schematically illustrate mobile smart device cases that are configured to magnetically couple with compatible mobile smart device accessories and accessory interface devices including wall or other surface mounting capable interface devices in accordance with example embodiments.

FIGS. 7A-7C schematically illustrate a gimbal mounting capable interface device that is configured to magnetically couple with compatible mobile smart devices and mobile smart device cases in accordance with example embodiments.

FIG. 7D schematically illustrates a gimbal magnetically coupled with a mobile smart device using the interface device of FIGS. 7A-7C in accordance with an example embodiment.

FIG. 7E schematically illustrates a mobile smart device case that may be configured to magnetically couple with a gimbal using an accessory interface device in accordance with an example embodiment.

FIG. 8A schematically illustrates a microphone mounting capable cold shoe interface accessory that is configured to magnetically couple with compatible mobile smart devices and mobile smart device cases in accordance with example embodiments.

FIGS. 8B-8D schematically illustrate further examples of microphones with cold shoe interface accessory mounting capable interfaces.

FIGS. 8E-8H schematically illustrate a microphone coupled interface accessory that is configured to magnetically couple with compatible mobile smart devices and mobile smart device cases in accordance with example embodiments.

FIGS. 9A-9E schematically illustrate a light source coupled interface accessory that is configured to magnetically couple with compatible mobile smart devices and mobile smart device cases in accordance with example embodiments.

FIGS. 10A-10H schematically illustrate louvre mounting capable interface accessories that are configured to magnetically couple with compatible mobile smart devices and mobile smart device cases in accordance with example embodiments.

FIG. 10E schematically illustrates a mobile smart device case that is configured to magnetically couple with compatible mobile smart device accessories and accessory interface devices including louvre mounting capable interface devices in accordance with example embodiments.

FIGS. 11A-11Z schematically illustrate example embodiments of mobile smart device cases, including cases for Apple smart devices including iphones 12 and 13 having Magsafe magnetic coupling capability and other Apple smart devices including earlier iphones that do not have Magsafe capability, such as iphones 7, 8, 9, X, 10, and 11, and cases for Samsung smart devices including Galaxy phones, and cases for Google smart devices including Pixel phones and Android phones, and cases for Oneplus smart devices, that are configured to magnetically couple with compatible mobile smart device accessories and accessory interface devices including microphones, lights, and tripod, cold shoe, gimbal, louvre, screw thread, or wall or other surface mounting capable accessories and accessory interface devices such as those shown and described with respect to the example embodiments of FIGS. 1A-10H.

### DETAILED DESCRIPTIONS OF EXAMPLE EMBODIMENTS

A mobile smart device accessory interface device is provided that includes a mobile smart device accessory interface device housing. A magnet array is disposed within the mobile smart device accessory interface device housing and is configured for magnetically coupling the mobile smart device accessory interface device with a mobile smart device or mobile smart device case or both. A mobile smart device accessory coupling interface is coupled to or integral with the mobile smart device accessory interface device housing and is configured for coupling thereto a mobile smart device accessory or a second mobile smart device accessory interface device or both.

A mobile smart device case is also provided that includes a mobile smart device case housing that is configured to enclose a mobile smart device and define camera and touchscreen display apertures. A mobile smart device case magnet array is disposed within the mobile smart device case housing and is configured for magnetically coupling thereto a mobile smart device accessory or a mobile smart device accessory interface device or both.

A mobile smart device case and mobile smart device accessory interface system is also provided that includes a mobile smart device case and a mobile smart device accessory interface device. The mobile smart device case includes a mobile smart device case housing that is configured to enclose a mobile smart device and define camera and touchscreen display apertures. A mobile smart device case magnet array is disposed within the mobile smart device case housing and is configured for magnetically coupling thereto a mobile smart device accessory or a mobile smart device accessory interface device or both.

The mobile smart device accessory interface device includes a mobile smart device accessory interface device housing. An accessory interface device magnet array is disposed within the accessory interface device housing and is configured for magnetically coupling the mobile smart device case with the mobile smart device accessory interface device.

A mobile smart device accessory coupling interface is also coupled to or integral with the mobile smart device accessory interface device housing and is configured for coupling thereto a mobile smart device accessory or a second mobile smart device accessory interface device or both. In combination, the mobile smart device case and the mobile smart device accessory interface device provide a system for magnetically coupling a mobile smart device accessory with a mobile smart device.

The accessory coupling interface may include a tripod mount interface. The tripod mount interface may be spaced apart from a center of the accessory interface magnet array to permit both portrait and landscape orientations of the mobile smart device case. The accessory coupling interface may be rotatable relative to an orientation of the mobile smart device case. The accessory coupling interface may include a rotatable coupling component to permit rotation of a mobile smart device accessory relative to the mobile smart device case. The accessory coupling interface may include both a cold shoe interface and a tripod mount interface.

The accessory coupling interface may include a cold shoe mount interface, a wall mount interface, a car mount interface such as a louvre mount interface, a screw thread interface including one or multiple screw thread configurations, a magic arm interface, a flexible arm interface, a mounting bracket interface, a gimbal mount interface, a microphone mount interface, such as for mounting a shotgun, conference and/or lavallier microphone, an accessory lighting interface or combinations of two or more of these interfaces.

A mobile smart device accessory interface device may include both a magnet array for magnetic coupling with a mobile smart device and/or a mobile smart device case that includes a magnet array and an accessory coupling interface that may couple with an accessory mechanically such as by providing a cold shoe mount, screw threads or unthreaded through holes for set screws, wood screws, drywall screws or nut and bolt attachments, a louvre attachment interface, an adhesive, a bayonet coupling interface, a compression bud, a snap component, a feedthrough receiver, or combinations of two or more coupling interface components. Accessory interface devices may also couple electrically, magnetically and/or wirelessly with an accessory.

### Mobile Smart Device Accessory Interface Device Overview

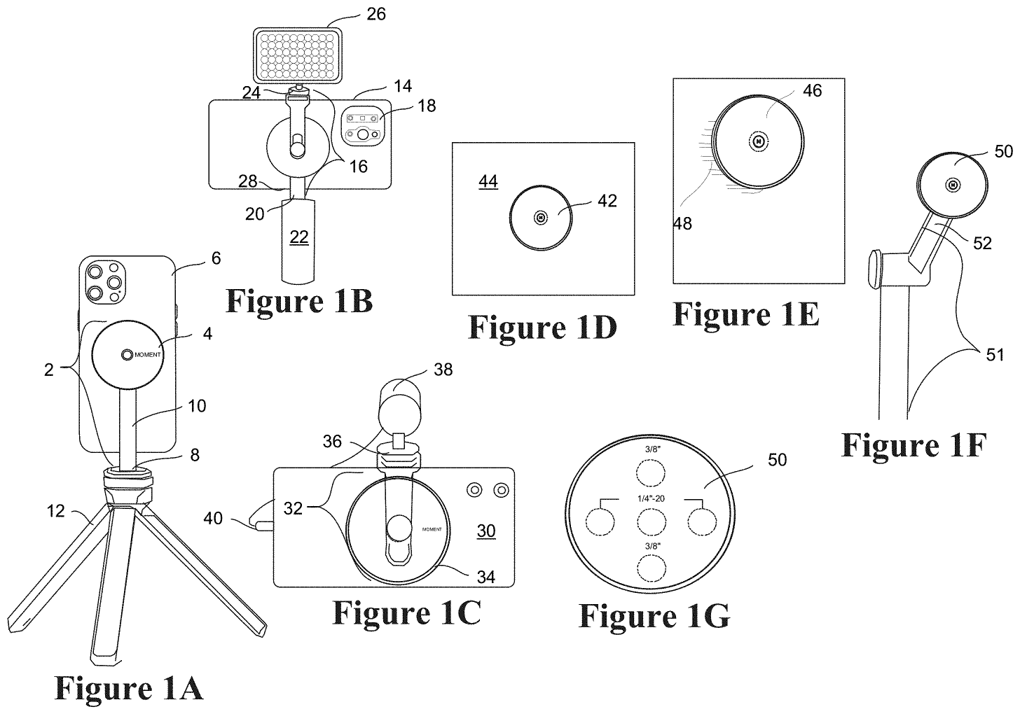

FIGS. 1A-1G schematically illustrate example embodiments of mobile smart device accessory interface devices that are configured to magnetically couple with compatible mobile smart devices and mobile smart device cases in accordance with example embodiments. The mobile smart device accessory interface devices shown in the photograph that includes FIGS. 1A-1G each also include one or more accessory coupling interfaces.

FIG. 1A shows an example embodiment of a mobile smart device accessory interface device 2 that includes an attachment interface 4 including an embedded magnet array which is shown magnetically coupled with a mobile smart device 6 in portrait orientation. The accessory interface device 2 of FIG. 1A also includes a tripod mount 8 at the end of a tripod mount arm 10. The tripod mount 8 is shown coupled onto a tripod 12 in FIG. 1A. The tripod mount arm 10 is long enough to permit the smart device 6 to be oriented in portrait mode without the tripod 12 being in the way.

FIG. 1B shows a mobile smart device case 14 that is magnetically coupled with a compatible mobile smart device accessory interface device 16 in accordance with an example embodiment. The mobile smart device case 14 is shown in FIG. 1B both enclosing a mobile smart device and providing an auxiliary lens attachment interface 18 to which a telephoto, wide angle, anamorphic or other auxiliary lens may be attached for enhancing the ability of the miniature camera module of the mobile smart device to capture high quality digital images. The accessory interface device 16 that is shown coupled to the case 14 in FIG. 1B includes a tripod mount interface 20 which is mounted on a cylindrical stand 22.

The accessory interface device 16 also includes a cold shoe interface 24. An LED lighting accessory 26 is mounted on the cold shoe 24. The mobile smart device case 14 enclosing the mobile smart device is oriented in landscape mode and the tripod mount arm 28 is short compared with the tripod mount arm 10 shown in FIG. 1A. However, the short tripod mount arm 28 is sufficient in length such that the stand 22 is not in the way of the case 14 in landscape mode.

FIG. 1C shows a mobile smart device 30, which is an Apple iphone device, oriented in landscape mode and coupled magnetically to a mobile smart device accessory interface device 32. The interface device 32 includes an attachment interface 34 including an embedded Magsafe™ compatible magnet array and a cold shoe mount 36 in accordance with an example embodiment. A microphone accessory 38 is mechanically coupled to the cold shoe mount 36.

The microphone 38 is also plugged into a lightning connector 40 of the Apple smart device 30 for capturing sound with a video recording.

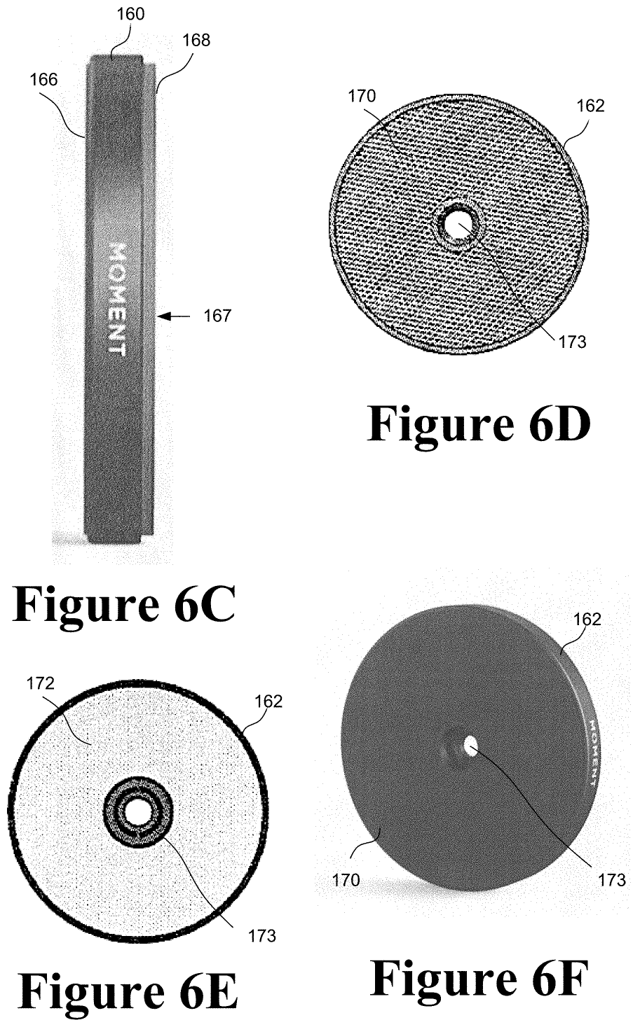

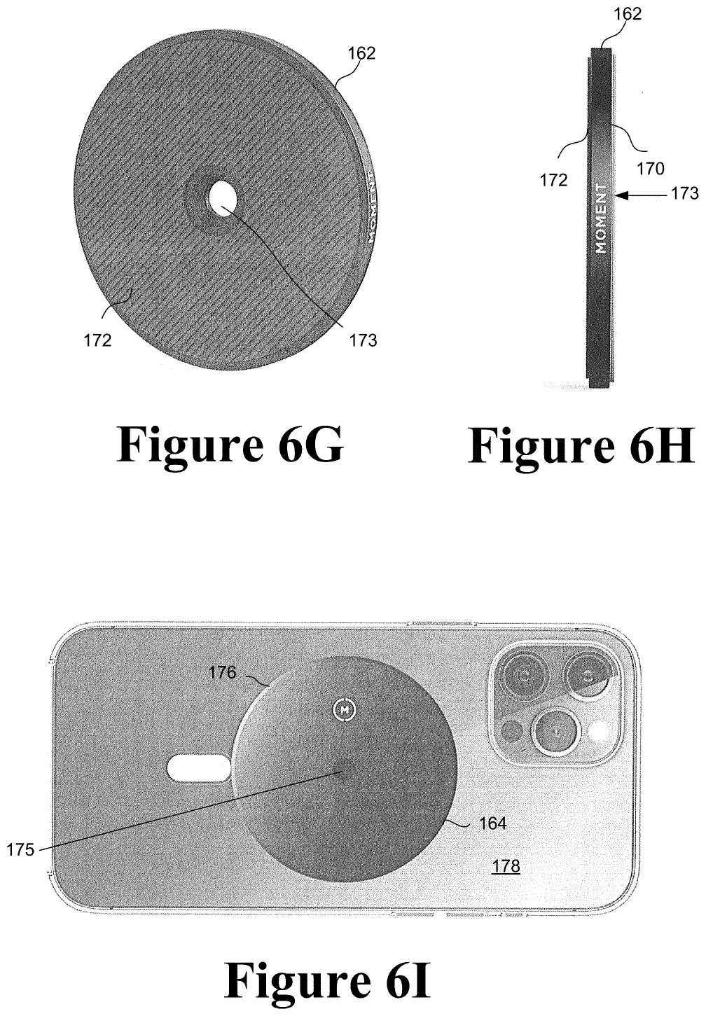

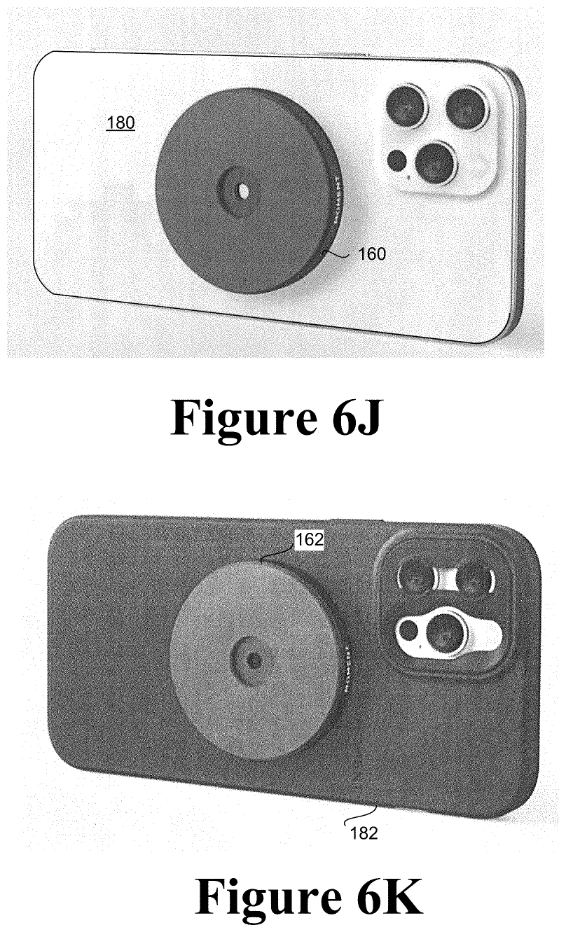

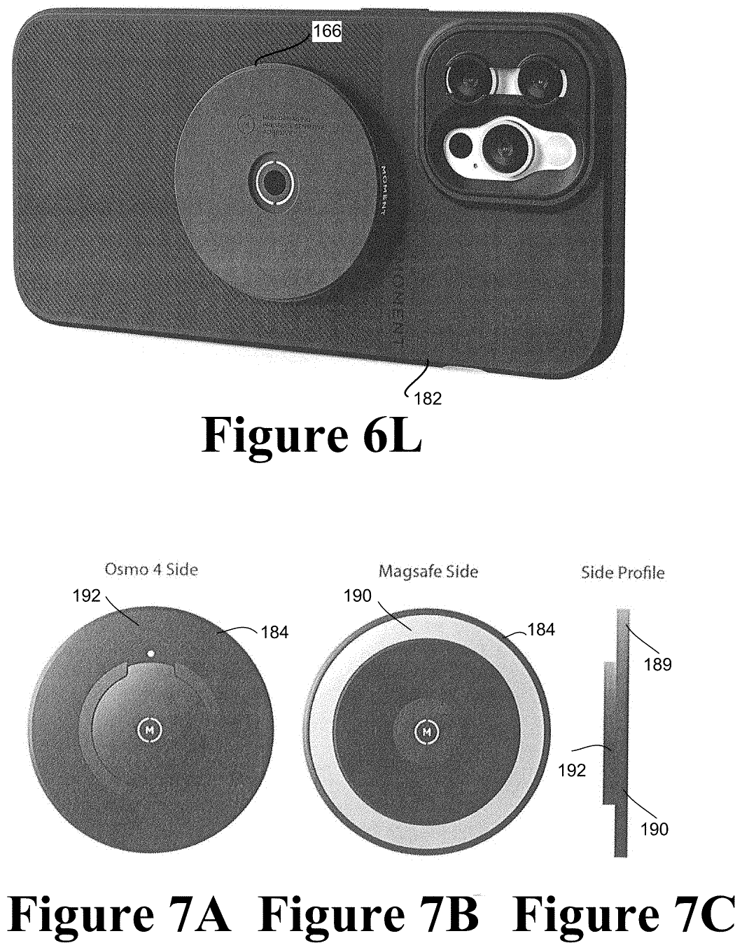

FIG. 1D shows a mobile smart device accessory interface device 42 attached in accordance with example embodiments to a flat surface 44 resembling a wall or the side of a bookshelf or a bedframe or a door or window or any other flat surface. A compatible mobile smart device or a mobile smart device enclosed within a compatible case containing a magnet array may be mounted by magnetic coupling to the accessory interface device 42 and thereby to the wall-like flat surface 44 shown in FIG. 1D. The device 42 may be mounted to the wall with an adhesive and/or with a screw (see FIG. 6B).

FIG. 1E shows a mobile smart device accessory interface device 46 attached in accordance with example embodiments to a louvre 48 such as are prevalent in automobiles for controlling air flow from heating and air conditioning vents. The accessory interface device 46 shown in FIG. 1E can couple to a wide variety of other thin things.

FIG. 1F shows a mobile smart device accessory interface device 50 that has an embedded magnet array for coupling on its frontside with a mobile smart device (6,30) or mobile smart device case 14. The mobile smart device accessory interface device 50 also includes on its backside one or more screw threaded recesses (not shown, but see FIGS. 1G, 2C, 5A and 5E). The mobile smart device accessory interface device 50 is shown in FIG. 1F attached to a stand 51 having a rotatable arm 52 with a screw (not shown) protruding from the end. FIG. 1G shows that the backside of the accessory interface device 50 of FIG. 1F includes multiple different screw threads for coupling with screws of different sizes and thread densities.

Referring for illustration to FIGS. 1A-1G, methods are also provided for coupling mobile smart device accessories (e.g., 12, 22, 26, 38, 51) with a mobile smart device (e.g., 6,30) and/or a mobile smart device case (e.g., 14). A mobile smart device accessory interface device (e.g., 2,16,32,42,46,50) may be magnetically coupled with a compatible mobile smart device (e.g., 6,30) and/or mobile smart device case (e.g., 14). A mobile smart device accessory (e.g., 12, 22, 26, 38, 51) may be integrated with, or coupled to an accessory coupling interface (e.g., 8,20,24,36) of, the mobile smart device accessory interface device (e.g., 2,16,32,42,46,50).

### Embedded Magnet Arrays

Magnet arrays may be embedded within mobile smart devices themselves and/or within mobile smart device cases that enclose and protect mobile smart devices. In example embodiments, magnet arrays are used for coupling mobile smart device accessories with mobile smart devices, cases and/or accessory interface devices that may themselves be equipped with a magnet array configured for magnetically coupling with a compatible mobile smart device and/or mobile smart device case.

These magnet arrays may be useful in example embodiments for other purposes such as for charging a mobile device and/or for charging a mobile device case and/or for charging a mobile device accessory. In other embodiments, a mobile device accessory may provide magnetic charging for a mobile device and/or for a mobile device case.

The arrangements of magnets in a magnet array embedded within a mobile device, mobile device case or mobile device accessory or accessory interface device may be selected to be compatible with magnet arrays or magnetic components disposed within mobile devices, mobile device cases and/or mobile device accessories to which magnetic coupling may be desired. The magnets may be formed from ferromagnetic materials, such as iron, cobalt, nickel, and/or nickel alloy, which may be configured to attract and couple with compatible arrays of ferromagnetic, paramagnetic and/or electromagnetic components.

The iphone 12 includes the magsafe™ magnetic array of Apple's design, which is found in the following document: https://developer.apple.com/accessories/Accessory-Design-Guidelines.pdf, which is incorporated by reference. Example embodiments of iphone 12 and iphone 13 cases and accessory interface devices are provided herein to be compatible with the magsafe™ magnetic arrays built into those mobile devices. Example embodiments of magnet arrays for magsafe™ compatible cases and accessories may include magnetic materials such as N45sh, N45m, N45H, and/or N48. In certain example embodiments, a thicker version of the magnetic array shown on page 83 of the above-cited Apple design document may be included in a compatible case, accessory and/or accessory interface device to provide enhanced magnetic coupling strength.

In additional example embodiments, particularly for Moment (M)force™ mobile device cases and accessory interface devices, including mobile device cases provided for non-magsafe mobile smart devices such as Google Pixel and Android devices, Samsung devices, and iphone 11 and earlier Apple devices, the magnetic force provided by the magnet array of thicker magnets, e.g., between 2 mm and 6 mm, between 3 mm and 5 mm, between 3.5 mm and 4.5 mm, or within a few tenths of a millimeter of four millimeters and in any event thicker than the suggested two millimeters for iphone 12 cases. Example (M)force embodiments may provide twice the coupling strength or more of the array suggested for iphone 12 compatibility. Qi and magsafe™ wireless charging can be integrated into these products in further example embodiments.

Magnetic arrays may include several magnets arranged in a variety of shapes, such as one or more lines having uniform or varying thicknesses, or one or more curved lines, or one or more bars, or one or more arrows or other symbols, alphabetical characters, or numbers, or arbitrary shapes, or one or more closed or open shaped objects, that may be magnetic or non-magnetic at their interior, such as a circular, semi-circular, oval, square, rectangular, hexagonal, octagonal, or other regular, irregular, symmetric or asymmetric polygonal object, or an object with one or more curved portions, or combinations thereof.

The materials used for the magnets in example embodiments of magnet arrays embedded within mobile smart device cases, accessories and/or accessory interface devices may include N45sh, N45m, N45H, and/or N48. In other embodiments, other ferromagnetic materials such as iron, cobalt, nickel, and/or nickel alloy may be used. The widths and thicknesses of the magnets may be selected based on the magnetic strengths desired for coupling with particular accessories depending on their size, weight, shape and magnetic properties. In certain example embodiments, a magnet array, such as may be embedded within a mobile smart device case, accessory or accessory interface device may have a magnetic coupling strength such that 10-15 pounds of force is involved to separate an accessory from an accessory interface device, case or mobile smart device.

In example embodiments, various numbers of magnets may be used in case, accessory and/or accessory interface device magnet arrays. Fewer than 10 magnets may be used to couple smaller accessory components, while 20 or 30 or 40 or 50 magnets may be used depending on the coupling requirements of the accessory. There are 36 magnets in the circle array of Apple's magsafe™ enabled iphone 12 series smart phones, while 2 additional magnets are used in an outrigger portion, which are provided as alignment magnets by Apple. The outrigger magnets may be used for square shaped accessories or other noncircular accessories.

The magnets of a magnet array in accordance with example embodiments may be attached to an accessory or accessory interface device using an adhesive or the magnets may be embedded in a resin or both. An aluminum or molded plastic cap may also be used for additional support to keep the magnets aligned within the array.

Mobile smart device accessory interface devices or mounts in accordance with example embodiments may be formed with machined or cast aluminum, with a thermoplastic polyurethane (TPU) padding. In other example embodiments, combinations of aluminum, polycarbonate and TPU may be used. In other example embodiments, silicone or a textile fabric may be used for padding.

### Tripod Connectors

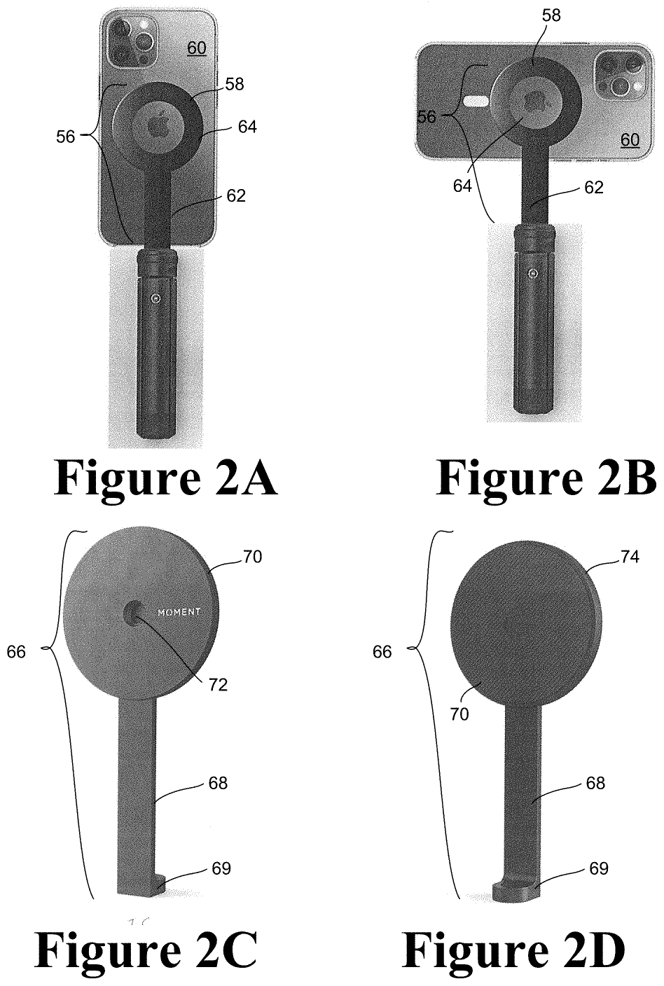

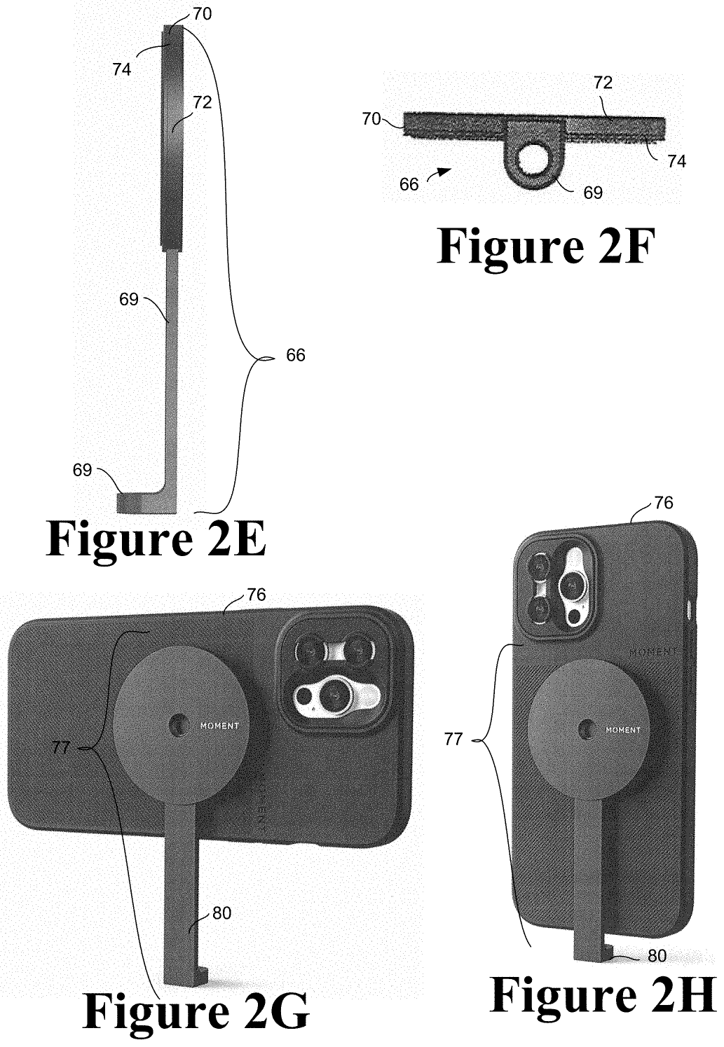

FIGS. 2A-2B illustrate a MagSafe™ compatible tripod or quadripod mount interface 56 in accordance with an example embodiment. The tripod or quadripod mount interface 56 shown in FIGS. 2A-2B may be configured to couple to various tripods, quadripods and stands including those having ¼-20″ interfaces. The tripod or quadripod mount interface 56 shown in FIGS. 2A-2B includes an attachment ring 58 with an embedded circular magnet array built into it that is compatible with the magsafe™ magnet array that is contained within Apple iphone 12 and iphone 13 series mobile smart devices. The iphone 12 series smart device 60 shown in FIGS. 2A-2B is able to rotate into landscape (FIG. 2B) or portrait (FIG. 2A) orientation. coupled to a tripod or quadripod mount interface 56 that is configured with a magnetic attachment ring 58 in accordance with this example embodiment. The magnetic attraction force between the magnet arrays contained within the iphone 12 and the attachment ring 58 may be configured to be strong enough to support the iphone 12 smart device 60, as well as a Moment (M)force case that includes a magnet array, as well as auxiliary lens and filter accessories. In example embodiments, this magnetic attraction force may be 2×, or more than 2×, the standard MagSafe™ array attachment force.

In alternative embodiments, the tripod or quadripod mount interface 56 of FIGS. 2A-2B may be modified to include outrigger magnets to prevent rotation of the iphone 12 series smart device 60. The tripod mount arm 62 may be shorter or taller than that shown and may have an adjustable height for accommodating different sizes of compatible phones and phone cases. The tripod mount 56 may be configured with Arca Swiss compatibility in an alternative embodiment. The attachment ring 58 containing the magnet array of the tripod or quadripod mount interface 56 can be square, round, or another shape, and it may have a hollow center 64 as shown in FIGS. 2A-2B or it may be configured as a (mostly) solid puck (see FIG. 2C). The tripod or quadripod mount interface 56 of FIGS. 2A-2B may be configured with built in MagSafe or Qi charging capability.

FIGS. 2C-2i illustrate an example embodiment of a screw thread mount and tripod mount combination accessory interface device 66. The combination interface 66 is shown in FIGS. 2C-2H includes a long tripod arm 68 with a tripod mount interface 69 at the one end and a (mostly) solid puck attachment plate 70 at the other end that includes an embedded circular magnet array. FIG. 2C shows a single screw thread accessory coupling interface 72 that is disposed at the center of the backside of the (mostly) solid puck attachment plate 70.

FIG. 2D shows the front side of the puck attachment plate 70 which includes a pad 74 for more softly receiving by magnetic attraction force a mobile smart device than would the harder surface beneath the pad. FIG. 2E shows the example combination interface 66 in side view. The pad 74 may be configured more or less thicker or thinner than shown in the example embodiment of FIG. 2E. FIG. 2F shows a bottom view of the combination interface 66.

FIGS. 2G-2i schematically illustrate mobile smart device cases (76,78) that are configured to magnetically couple with accessory interface devices (77,79) in accordance with example embodiments that are in turn configured to couple with compatible mobile smart device accessories, such as tripods, gimbals, microphones and LED lights. FIGS. 2G-2H illustrate a tripod mount interface device 77 that includes a long tripod mount arm 80, while FIG. 2i illustrates a tripod mount interface device 79 that includes a short tripod mount arm 81.

### Cold Shoe Mounting

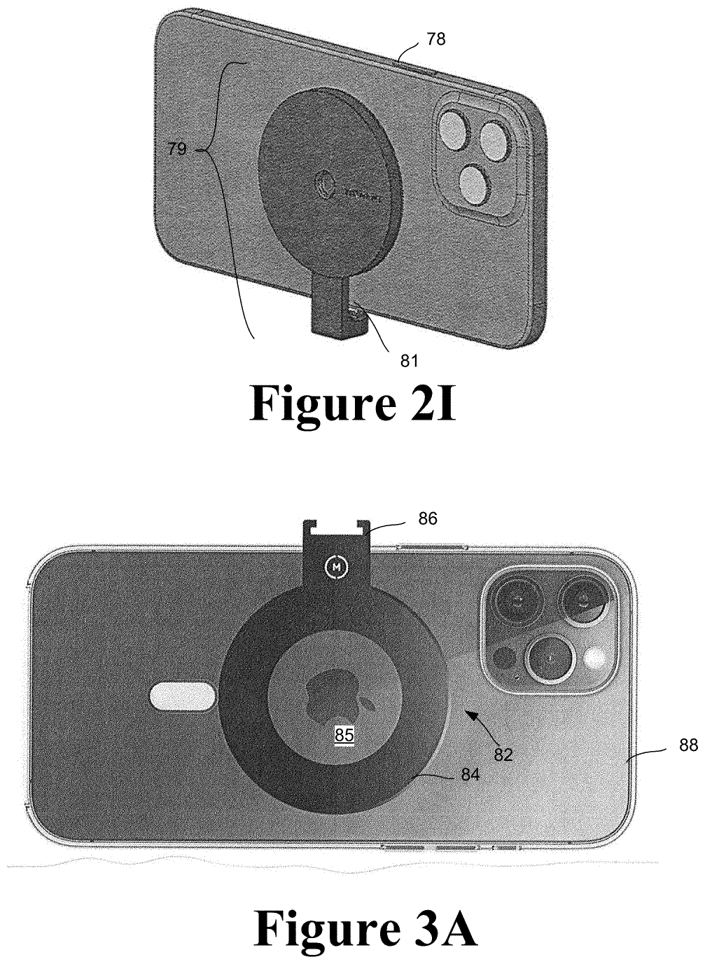

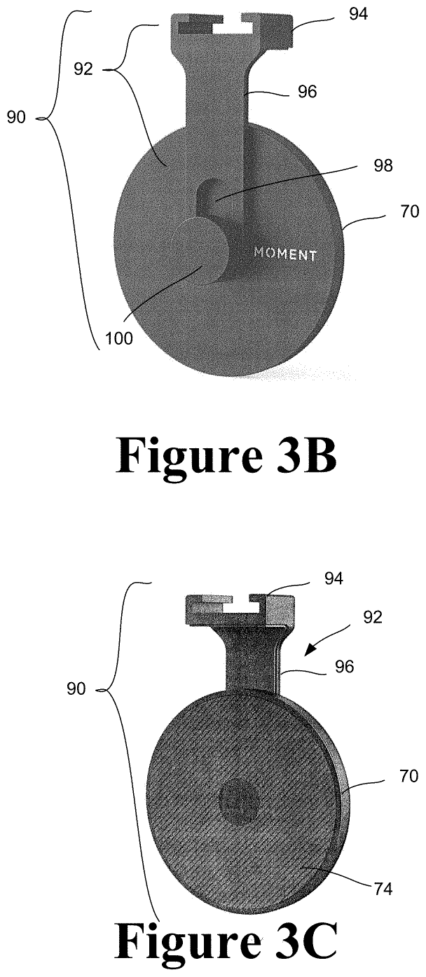

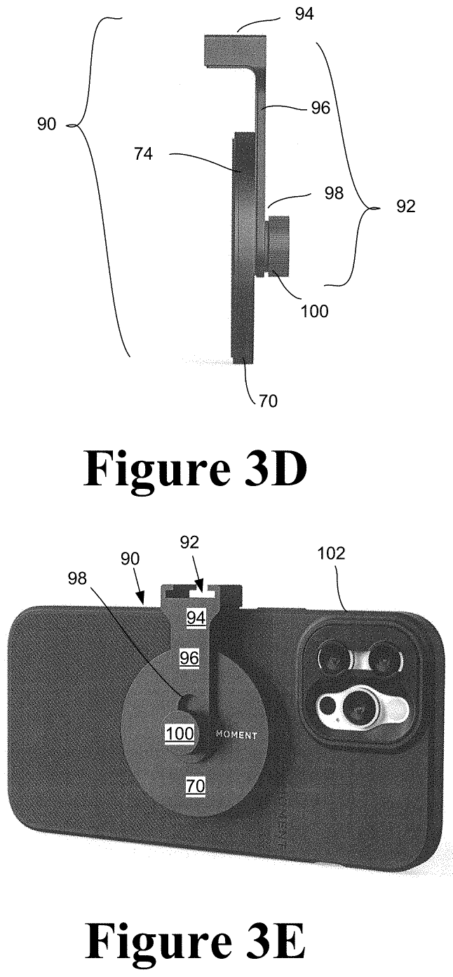

FIGS. 3A-3E illustrate example embodiments of mobile smart device cold shoe interface devices. The cold shoe interface device 82 of FIG. 3A includes a ferromagnetic attachment ring 84 with a hollow center coupled magnetically with a Magsafe compatible iphone 12 series smart device 88 and a cold shoe 86.

The mobile smart device cold shoe interface device 90 of FIGS. 3B-3D includes a puck attachment plate 70 with a pad 74 on the front side for protecting a mobile smart device or case during magnetic coupling. A cold shoe mount interface 92 includes a cold shoe 94 at one end of a cold shoe arm 96 and defines a cold shoe arm length adjustment slot 98 at the other end of the cold shoe arm 96. A thumb screw 100 is screw thread coupled to the screw thread accessory coupling interface 72 (see FIG. 2C) and is within the cold shoe arm length adjustment slot 98, such that the length of the cold shoe arm 96, or the distance between the cold shoe 94 and the center of the puck 70, is fixed when the thumb screw 100 is tightened and the length of the cold shoe arm 96 may be adjusted when the thumb screw 100 is loosened.

A mobile smart device cold shoe interface device in accordance with example embodiments provides an efficient way to magnetically couple a cold shoe mount with a mobile smart device to mount a light or microphone to the smart device. A magnet array embedded within the cold shoe interface device may be magnetically coupled with a compatible magnet array embedded within an Apple iphone 12 or iphone 13 series smart device or with a magnet array that is embedded within a mobile smart device case enclosing mobile smart devices with or without embedded magnet arrays.

The magnet arrays may use outrigger magnets to prevent rotation or the mobile smart device may be rotatable along with the cold shoe mount relative to the cold shoe interface device, e.g., for permitting changes in orientation of the mobile smart device between landscape and portrait image capture modes. The length of a cold shoe arm and/or of a tripod mount arm or both may be adjustable to set the mobile smart device and/or the cold shoe at different heights for use with different sizes and shapes of smart devices. The cold shoe mount arm may be rotatable relative to the cold shoe interface device so that the cold shoe can accommodate mounting accessories on the top, bottom or either side of the smart device.

Changeable accessory attachment arms may provide more orientational and positional options. A dual cold shoe mount interface device and/or a single or double cold shoe mount device with multiple ¼-20″ or other thread density screw thread recess attachment interfaces may permit coupling and use of a greater number of accessories at once.

The attachment plate of the accessory interface device may be square, rectangular, round, elliptical or otherwise oblong, or triangular or arbitrarily curved or shaped to match compatible magnet arrays for coupling accessories with mobile smart devices. The attachment plate may have a hollow center or may be configured as a (mostly) solid puck. MagSafe or Qi charging may be built-in.

FIG. 3E schematically illustrates an example embodiment of a mobile smart device case 102 that includes an embedded (M)force magnet array configured to magnetically couple with compatible mobile smart device accessories and accessory interface devices including the mobile smart device cold shoe interface device 90 described with reference to FIGS. 3B-3D above.

### Tripod and Cold Shoe Accessory Combination Mounting

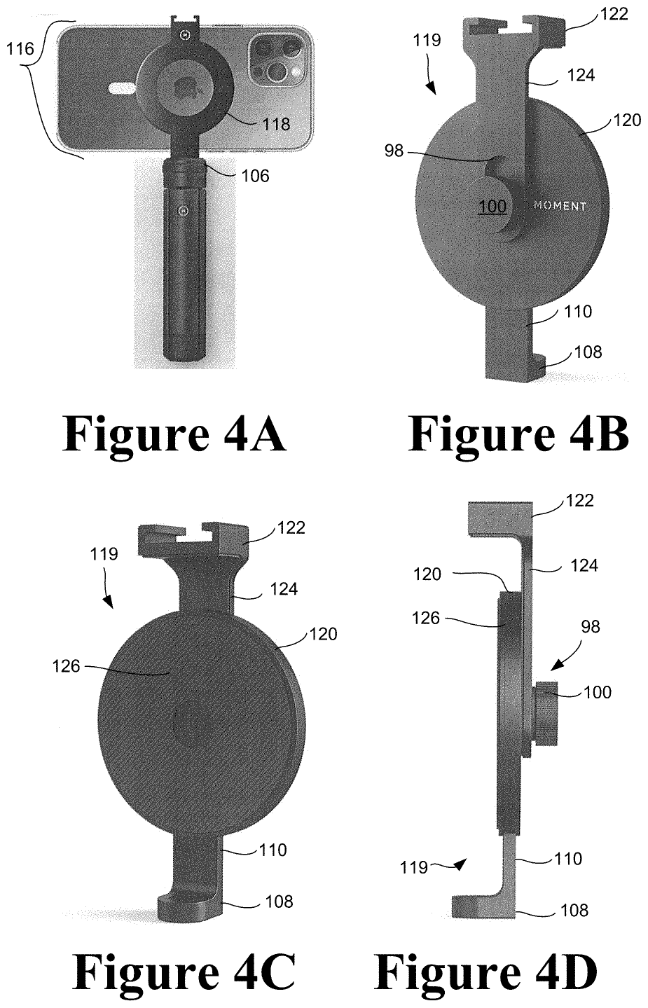

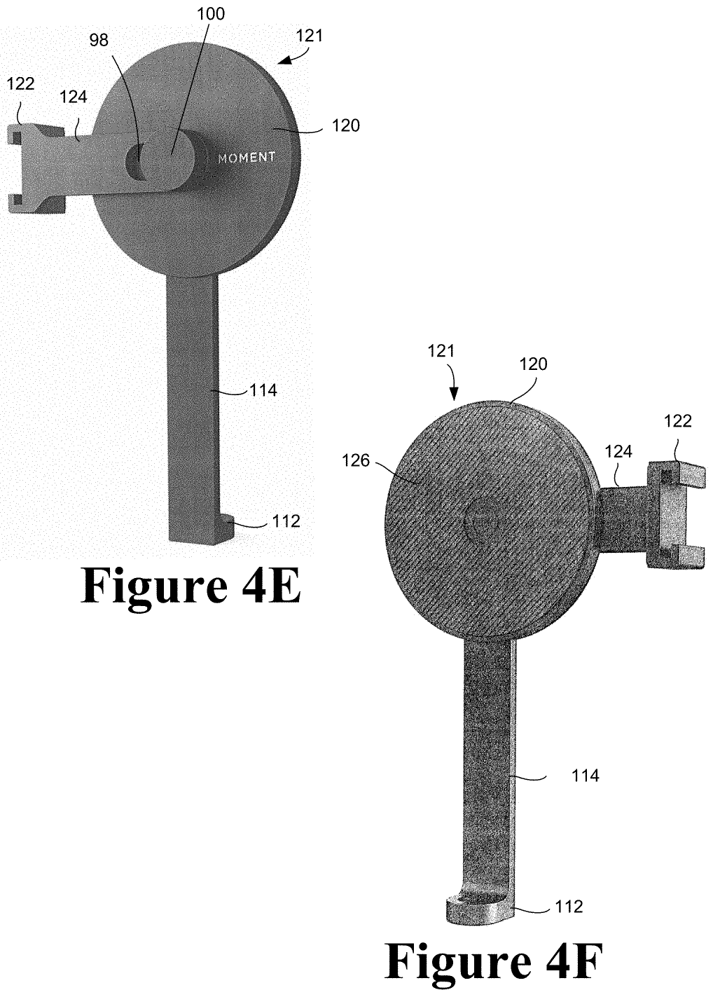

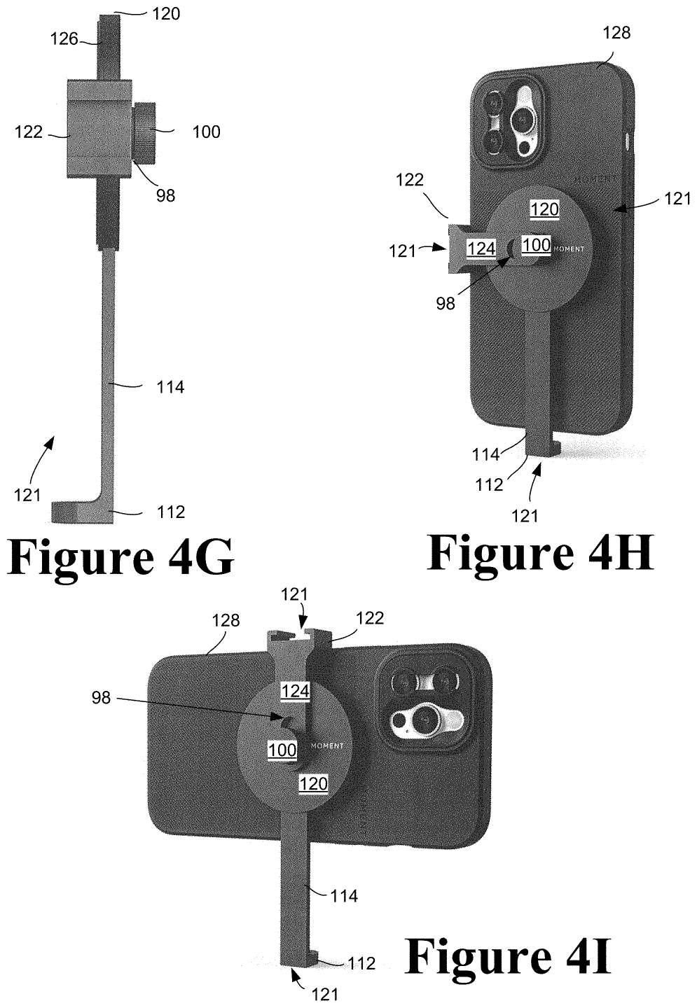

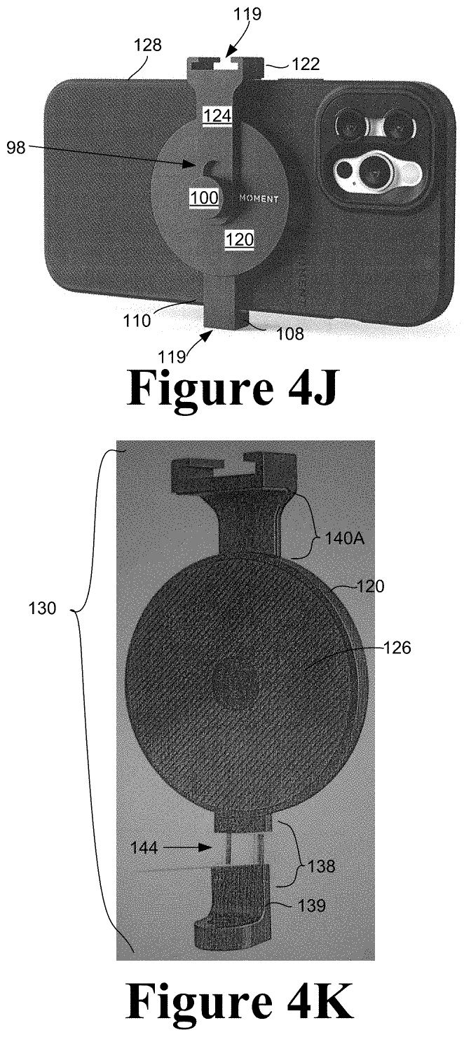

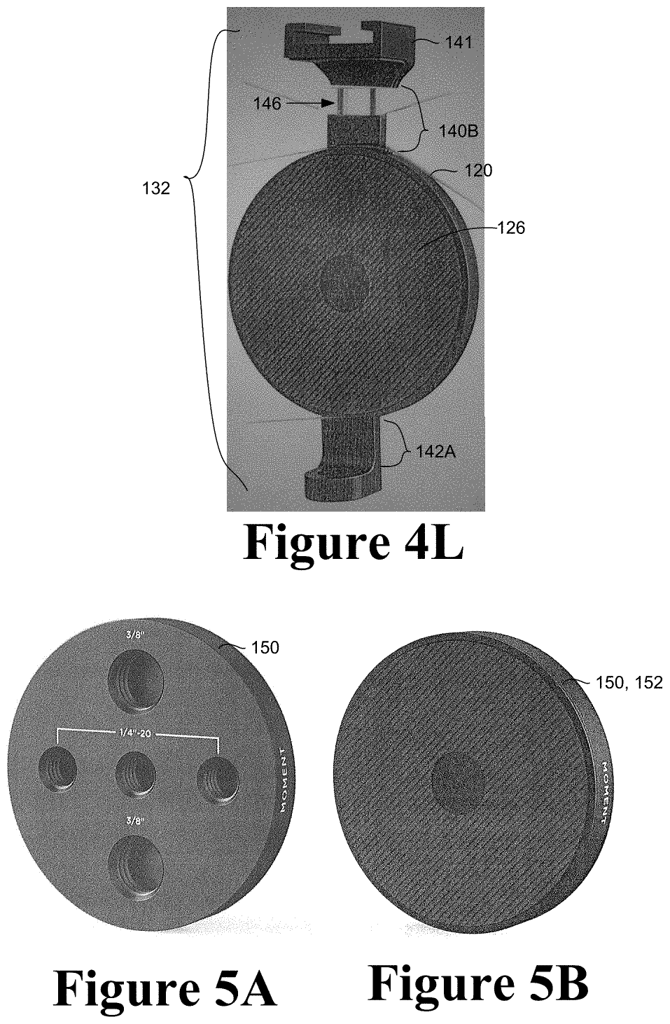

FIGS. 4A-4L schematically illustrate several example embodiments of tripod and cold shoe mounting capable combination interface devices that are configured to magnetically couple with compatible mobile smart devices and mobile smart device cases in accordance with example embodiments.

FIG. 4A illustrates an example embodiment that includes a first tripod mount interface 106. FIGS. 4B-4D and 4j illustrate another example embodiment that includes a second tripod mount interface 108 disposed at one end of a short tripod mount arm 110. FIGS. 4E-4i illustrate another example embodiment that includes a third tripod mount interface 112 disposed at one end of a long tripod mount arm 114.

The mobile smart device accessory interface device 116 of FIG. 4A includes a magnetic ring attachment plate 118 that includes a circular magnet array and is hollow in the center. FIGS. 4B-4L each include a (mostly) solid puck attachment plate 120 and a cold shoe mount interface 122 disposed at one end of a cold shoe arm 124 that is rotatable relative to the orientation of the puck attachment plate 120 and is adjustable in length or distance between the cold shoe mount 122 and the center (or any point) of the puck attachment plate 120. The slot 98 and thumb screw 100 are the same in this example embodiment as those items (98,100) described above with reference to the example embodiments of FIGS. 3B-3E.

In the example embodiments illustrated in FIGS. 4B-4L, the distance between the tripod mount interface 108 and/or the cold shoe mount interface 122 may be adjusted to act as a clamp for added support for the mobile smart device. Cold shoe arm 124 may be rotatable relative to the puck 120 and tripod mount interface 108 to accommodate rotating a smart phone from portrait to landscape. Changeable accessory attachment arms may be used including dual cold shoes, or a cold shoe and multiple ¼-20″ attachments to attach multiple accessories at once in an example embodiment.

In other example embodiments, Arca Swiss compatibility is provided. The attachment plate 120 can be square, round, or another polygonal or curved shape, and attachment plates (118,120) may have hollow centers as in the example of FIG. 4A or may have a puck configuration 120 as in the examples of FIGS. 4B-4M. MagSafe or Qi charging may be built in. FIGS. 4B-4C and 4F-4G each show a pad 126 on the smart device and case coupling frontside of the puck 120 for rendering significantly more inelastic the impact shocks and stresses to the mobile smart device from collisions with the frontside surface of the puck 120 occurring during the attaching and detaching of the mobile smart device to and from, respectively, the magnetic hold of the puck 120.

FIGS. 4H-4j schematically illustrate a mobile smart device case 128 in portrait, portrait and landscape orientations, respectively. The case 128 is configured with a Mforce magnet array to magnetically couple with compatible mobile smart device accessories and accessory interface devices including tripod and cold shoe mounting capable combination interface devices (e.g.,116,119,121) in accordance with example embodiments.

FIGS. 4B-4j schematically illustrate cold shoe mounting capable interface devices (119,121) that each include a length and orientation adjustable cold shoe arm coupling mechanism including a thumbscrew 100 coupled within a screw thread recess 72 (see FIG. 2C) and a slot 98 defined at an opposite end of a cold shoe arm 124 as the cold shoe 122 in accordance with example embodiments.

FIGS. 4K-4L schematically illustrate tripod and cold shoe mounting capable combination interface devices 130,132, respectively, each including a puck 120 with a padded front surface 126 configured with an embedded magnet array for magnetic coupling with a compatible embedded magnet array of a mobile smart device and/or a mobile smart device case. The tripod mount arm 138 of the device 130 of FIG. 4K has an adjustable length. The cold shoe mount arm 140B of the device 132 of FIG. 4L has an adjustable length. The lengths of both the tripod mount arm and the cold shoe mount arm of the device are adjustable in accordance with example embodiments. The length adjustability of the arms 138,140B is provided by the separability of end segments 139,141, respectively, by sliding independently away from or towards the center of the device 130,132 along embedded rail pairs 144,146.

### Screw Thread Mounting Interfaces

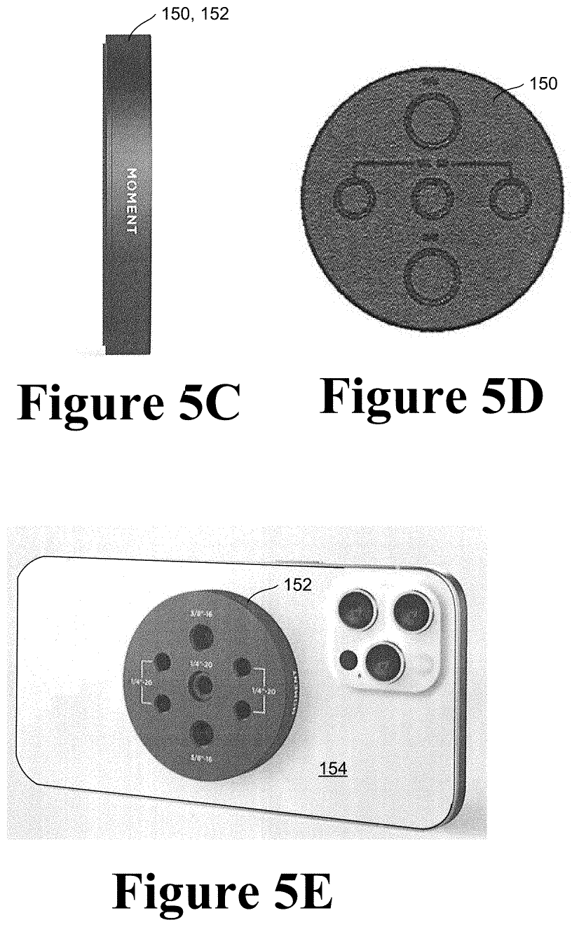

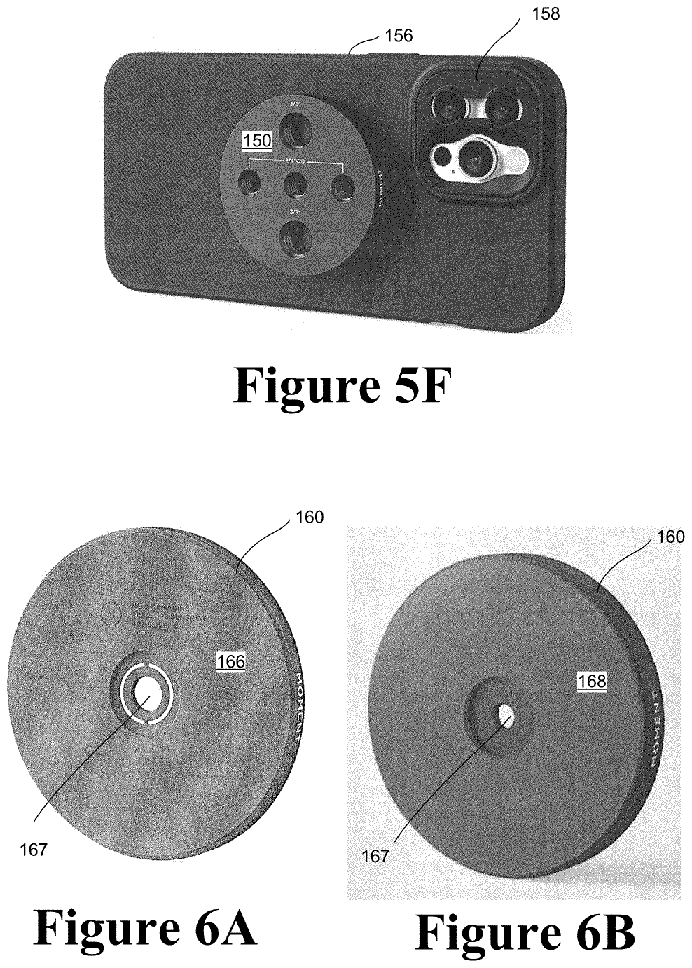

FIGS. 5A-5F schematically illustrate universal screw thread mounting capable interface devices (e.g.,150,152) that are configured to magnetically couple with compatible mobile smart devices 154 and mobile smart device cases 156 in accordance with example embodiments. FIGS. 5A-5F illustrate example embodiments of universal ¼″-20 and ⅜″-16 pucks (e.g., 150,152) each with embedded magnet arrays configured for magnetic coupling of Magsafe and/or Mforce cases and smart devices to tripods, flexible arms, mounting brackets and other accessory attachments with screw thread coupling interfaces.

FIG. 5F schematically illustrates a mobile smart device case 156 that is configured to magnetically couple with compatible mobile smart device accessories and accessory interface devices including universal screw thread mounting capable interface devices (e.g.,150,152) in accordance with example embodiments. The mobile device case 156 defines a camera aperture which is square-shaped with rounded corners in the example embodiment of FIG. 5F. An auxiliary lens attachment interface 158 is coupled within the camera aperture in the example embodiment of FIG. 5F.

### Wall Mounting Interfaces

FIGS. 6A-6L schematically illustrate wall or other surface mounting capable interface devices (e.g.,160,162,164) that are configured with embedded magnet arrays to magnetically couple with compatible magnet arrays embedded within mobile smart devices and mobile smart device cases in accordance with example embodiments. Example embodiments include wall or other flat surface mounting interface devices 160,162,164 that attach to the wall with an adhesive backer 166,170, e.g., that may be similar to command strips or 3M VHB tape. A compatible smart device or smart device case may be magnetically coupled to the wall mount interface 160,162,164 in portrait or landscape orientation. Mobile smart device wall mount interface devices 160,162,164 may be stuck anywhere for magnetically attaching a smart device or case to any wall or other flat surface.

In example embodiments, a small universal mount for iPhone 12 or other smart devices enclosed within (M)force cases includes strong magnets on one side 168,170 and a 3M adhesive 166,172,176 on the other. A super-thin, 2.25-inch wide circle may be the size of the magnetic attachment ring or puck 160,162,164. This mount 160,162,164 may adhere in certain example embodiments to almost anything flat. The puck 160,162,164 may include a countersunk through-hole 167,173,175 in example embodiments so that the puck 160,162,164 can be alternatively screwed into a stud or drywall anchor.

Compatible with or without a case, this mount also includes a frontside 168,170 (M)Force magnet array in example embodiments which is even stronger than standard accessories, to ensure the mobile smart device doesn't fall off. A grip pad 168,170 is also provided in example embodiments to prevent the mobile smart device from slipping. The magnet array may include outrigger magnets to prevent rotational slipping. Padded contact points may be provided in example embodiments to keep the smart device safe from collisional stresses.

The attachment plate 160,162,164 may be made of metal, or plastic, and/or may be covered with a fabric in example embodiments. The attachment plate 160,162,164 can mount to a wall or other flat surface via screw, adhesive, velcro, snaps, hooks, feedthrough, compression bud or bayonet coupling in example embodiments.

FIGS. 6i-6j illustrate mobile smart devices 178,180 that are configured to magnetically couple with compatible mobile smart device accessories and accessory interface devices 160,162,164 including wall or other surface mounting capable interface devices 160,162,164 in accordance with example embodiments. FIGS. 6K-6L schematically illustrate mobile smart device cases 182,184 that are configured to magnetically couple with compatible mobile smart device accessories and accessory interface devices including wall or other surface mounting capable interface devices in accordance with example embodiments.

### Gimbal Accessory Mounting Interfaces

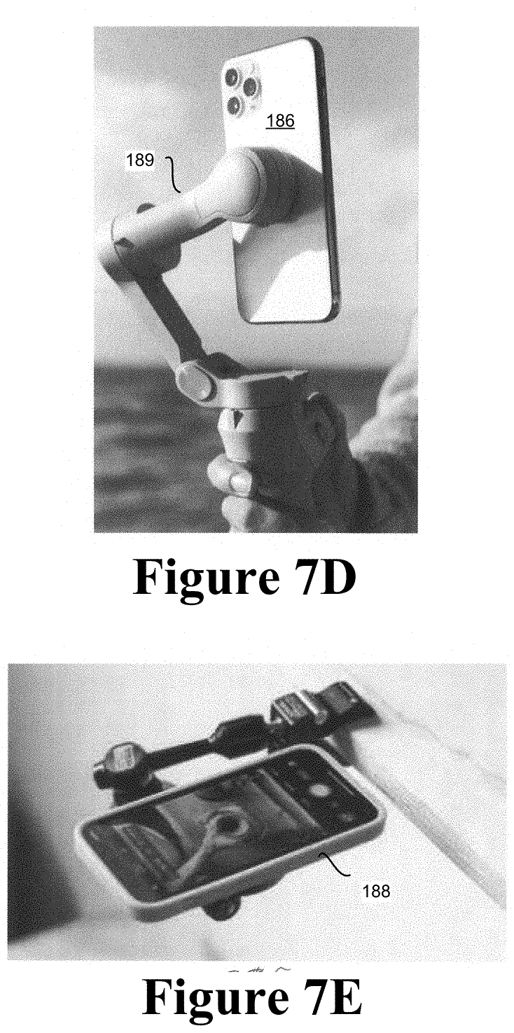

FIGS. 7A-7C schematically illustrate a gimbal mounting capable interface device 184 that is configured to magnetically couple with compatible mobile smart devices 186 and mobile smart device cases 188 that are configured in accordance with example embodiments. FIG. 7D schematically illustrates a gimbal 189 magnetically coupled with a mobile smart device 186 using the interface device 185 of FIGS. 7A-7C in accordance with an example embodiment.

The gimbal mount device 184 of FIGS. 7A-7C attaches magnetically to iphone 12 and iphone 13 series smartphone devices and to (M)force capable mobile device cases on a Magsafe side 190. The gimbal mount 184 of FIGS. 7A-7C also attaches magnetically to DJI Osmo 4 gimbals via DJI's proprietary magnet on an Osmo 4 side 192.

In example embodiments, attachment on the gimbal side 192 may be on a track, and may be able to slide left and right and then lock into place to balance the phone 186 on the gimbal 189. The gimbal side attachment 192 could be mechanical and/or magnetic. Example embodiments include adjustable and nonadjustable fixed attachments. The magnet array in the gimbal coupling interface could be modified to be Magsafe or M(force) compatible or otherwise to be compatible with a magnet array provided in a universal gimbal mount adapter. Outrigger magnets may included with the magnet array to prevent rotation at the coupling interface.

FIG. 7E schematically illustrates a mobile smart device case188 that includes an embedded magnet array configured to magnetically couple with a compatible gimbal magnet array or using an accessory gimbal interface device in accordance with an example embodiment.

### Microphone Accessories and Mounting Interfaces

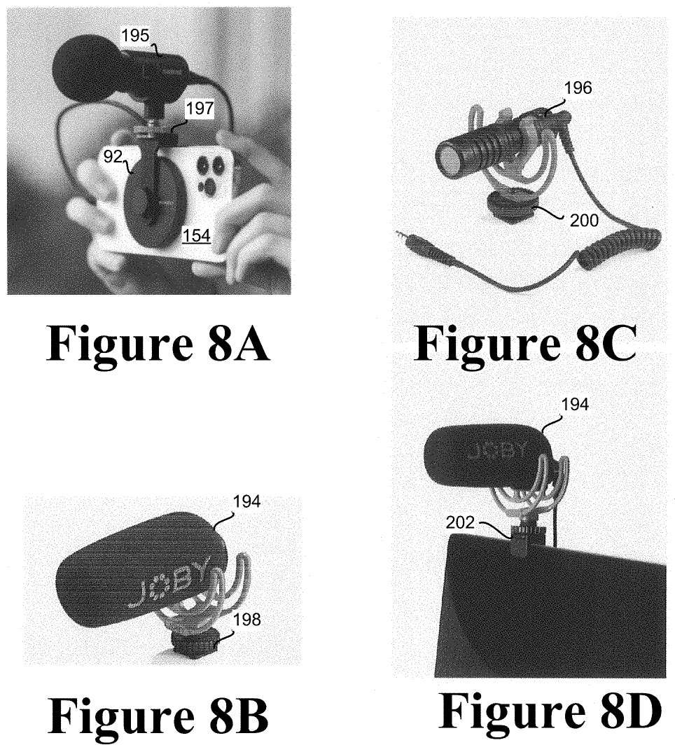

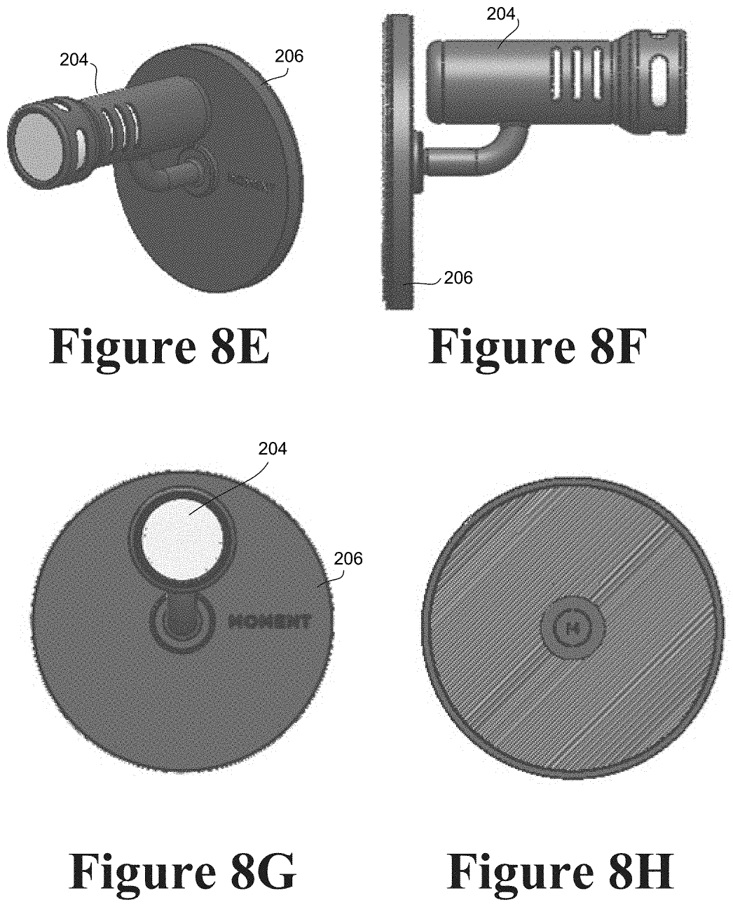

FIG. 8A schematically illustrates a microphone mounting capable cold shoe interface accessory 92 that is configured to magnetically couple with compatible mobile smart devices 154 and mobile smart device cases in accordance with example embodiments. FIGS. 8A-8D schematically illustrate examples of microphones 194,195,196 with cold shoe interface accessory mounting capable interfaces 197,198,200,202. FIGS. 8E-8H schematically illustrate a microphone 204 coupled with an interface accessory 206 that is configured to magnetically couple with compatible mobile smart devices and mobile smart device cases in accordance with example embodiments.

A wired or wireless microphone receiver may attach to the back of an iphone 12 via Magsafe or to another mobile smart device via an Mforce compatible case in example embodiments. Data from the microphone receiver may transmit wirelessly to the smartphone via bluetooth, wifi, or other wireless protocol in example embodiments. Built-in Qi or MagSafe charging may be included in example embodiments to charge the smartphone device. Power may be received from the smartphone via reverse wireless charging in example embodiments.

The microphone 204 illustrated at FIGS. 8E-8H may magnetically attach to an iphone 12 or iphone 13 series smart device or to an Mforce compatible device or case. The example microphone 204 of FIGS. 8E-8H may be configured to be low profile enough to not interfere with camera keep out cones. The microphone 204 may plug into an iphone via lightning or USB connector or to another mobile smart device such as a Google Pixel or Android device or a Samsung smartdevice by analogous connectors.

### Lighting Accessories

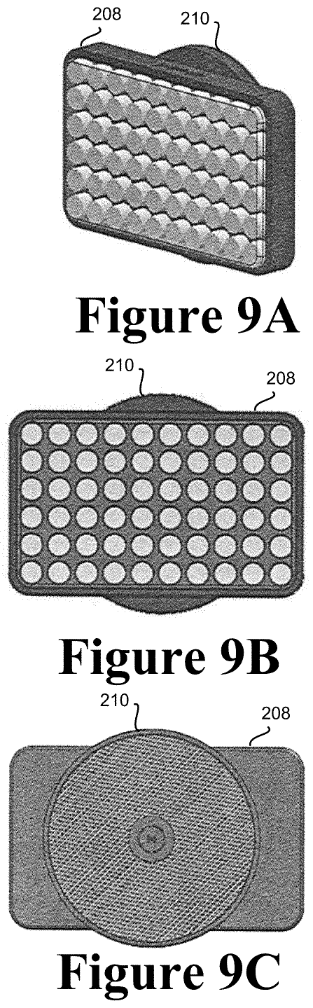

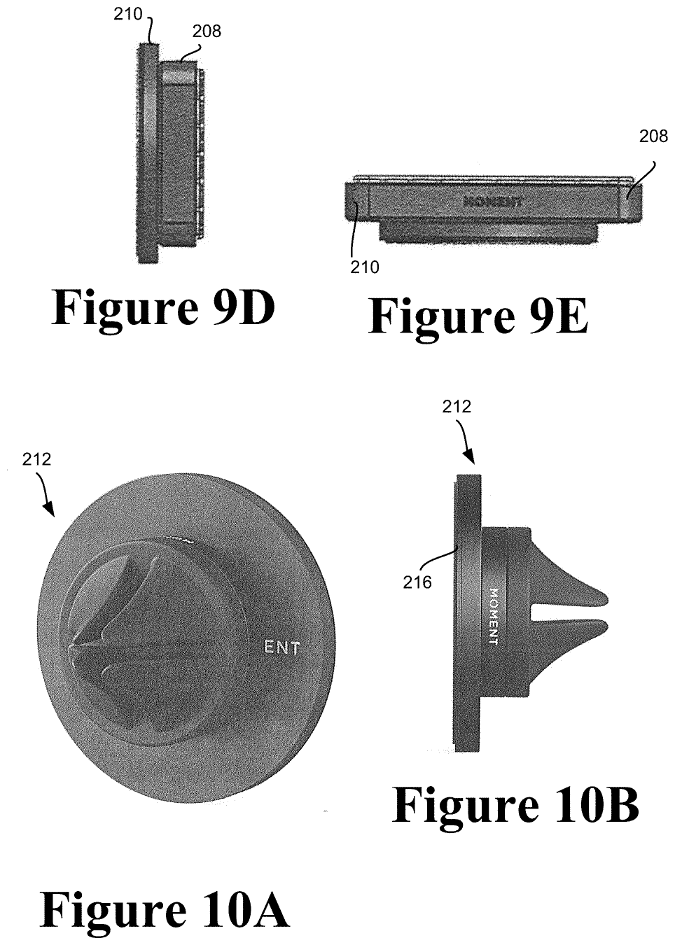

FIGS. 9A-9E schematically illustrate a light source 208 coupled to an interface accessory 210 that is configured to magnetically couple with compatible mobile smart devices and mobile smart device cases in accordance with example embodiments. With MagSafe or Mforce or other magnetic coupling capability, light panels 208, flashes, and ring lights can be attached to a mobile smart device or case via magnets built-in to the accessory 210 and magnets built-in to the mobile smart device or case.

The lighting device may be configured in example embodiments to be low profile enough to not interfere with camera keep out cones. The lighting device (e.g.,26,208) may be able to sync via a hardwire connection or via bluetooth or via an independent control interface in example embodiments.

A square LED light panel about half the size of an iphone 12 mini may be sufficiently bright in example embodiments. A light accessory can be configured to flip up to be used with a front facing camera in example embodiments. A light can also be configured to wrap around an entire smartphone to act as a ring light in example embodiments. Color temperature of the light may be adjustable and the light can be operated as a flash in example embodiments.

Built in Qi or MagSafe charging may be used to charge a smartphone having a LED light attached. The LED light may be subject to wireless or wired charging and control. A flip up diffusion light may be used that stays on all or most of the time in example embodiments. The flip-up diffusion light may keep a subject lit when shooting video. The diffusion light may sit on the back of the smartphone and then flip-up when shooting in selfie mode.

A flash may be configured for point and shoot and/or for more artistic photography in example embodiments. Features similar to those found on a Profoto C1 may be used that stay on the smartphone. Ring light kits may be used to make stationary ring lights easier to use, and/or a small mobile ring light may be used for on location shooting in example embodiments. A selfie ring light may snap or otherwise couple to a smartphone that goes around a selfie camera.

### Car Mount Interfaces

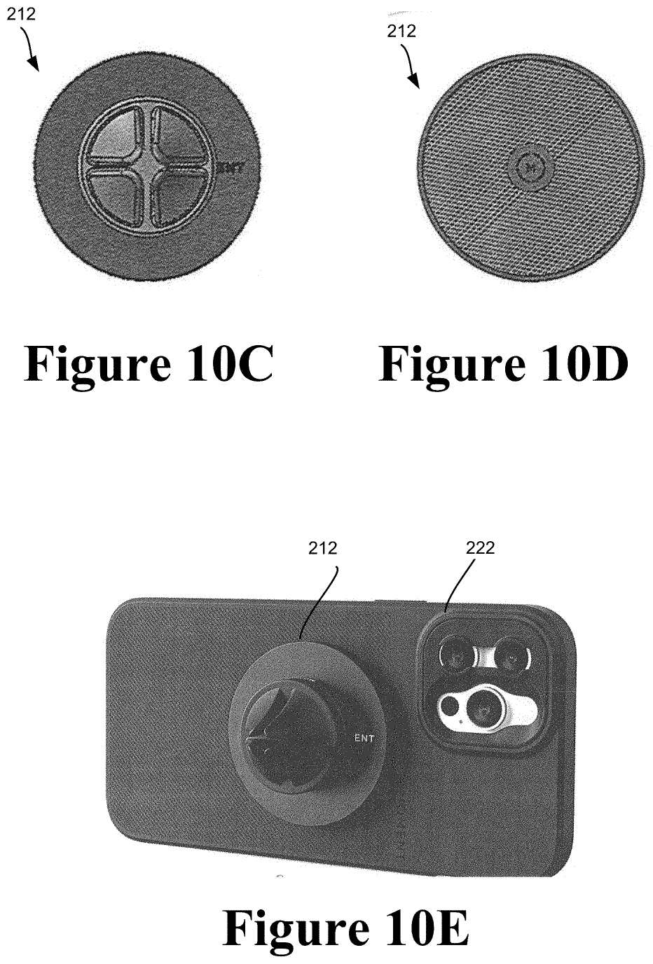

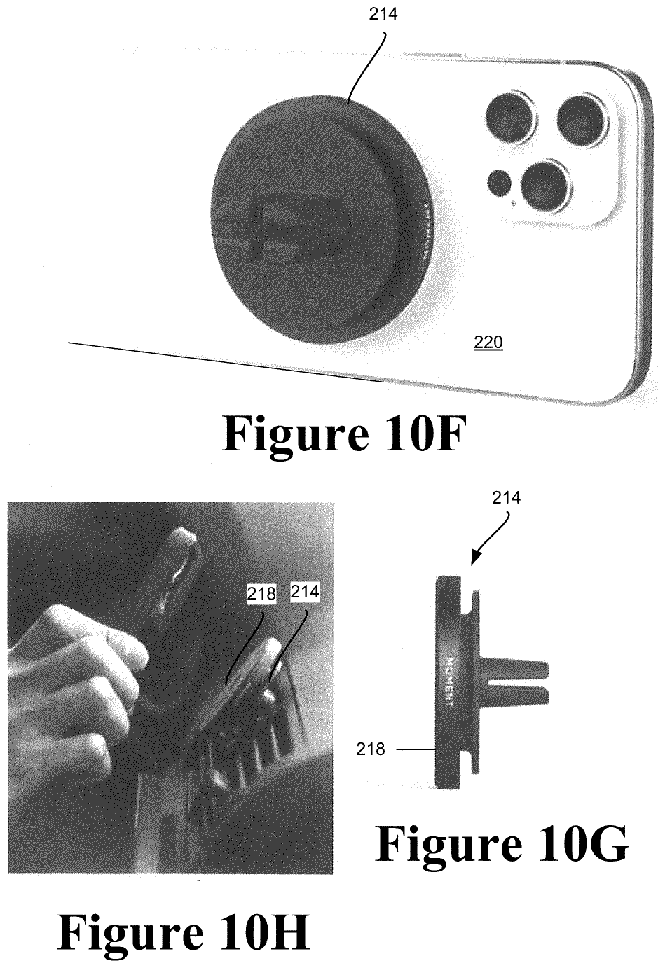

FIGS. 10A-10H schematically illustrate louvre mounting capable interface accessories 212,214 that are configured to magnetically couple on a front side 216,218 with compatible mobile smart devices 220 and mobile smart device cases 222 in accordance with example embodiments. FIG. 10E schematically illustrates a mobile smart device case 222 that is configured to magnetically couple with compatible mobile smart device accessories and accessory interface devices including louvre mounting capable interface devices 212,214 in accordance with example embodiments.

### Hot Shoes and Cold Shoes

A hot shoe or a cold shoe may be attached to a camera-enabled mobile device using a magnetic coupling in accordance with an example embodiment. A flash or other light source or another compatible accessory may then be mounted to the hot shoe or cold shoe. The hot shoe or cold shoe may take the form of an angled bracket. The hot shoe may include a metal bracket surrounding a metal contact point which completes an electrical connection between camera and accessory for standard, brand-independent flash or audio or infrared camera or preview camera or 3D camera or other accessory synchronization. The hot shoe may be configured with or without flash contacts, and may be configured to hold accessories such as a rangefinder, or a flash connected by a cable. The dimensions of the hot shoe may be defined by the International Organization for Standardization in ISO 518:2006.

The hot shoe may be shaped somewhat like an inverted, squared-off “U” of metal or polymer material. A matching adapter on the bottom of a flash or other accessory unit may slide in from the back of the camera and may be secured by a clamping screw on the flash or other accessory. In the center of the “U” may be a metal contact point for the hot shoe. Other additional metal contacts may be configured and disposed within the “U” of the hot shoe.

These may allow for more communication between the camera and an accessory coupled to the shoe, such as communication of information about a power rating to the camera, set camera settings automatically or as received from a user input device, transmit color temperature data about the emitted light, and/or can be commanded to light a focus-assist light or fire a lower-powered pre-flash for focus-assist, metering assist or red-eye effect reduction.

Modern cold shoes may be coupled magnetically to a camera-enabled mobile device in accordance with an example embodiment. An accessory shoe without electrical function may be coupled to a camera-enabled mobile device as a cold shoe using a magnetic coupling in accordance with an example embodiment. The cold shoe may couple to an off-camera flash unit that may be mounted on a stand and connected to the camera by cable or triggered wirelessly such as by blue tooth. A stereo microphone or electronic viewfinder may be coupled to a cold shoe that is magnetically coupled to a camera enabled mobile device in accordance with an example embodiment. In addition, gps satellite location units may utilize the accessory shoe for mounting to the camera.

### Arca Swiss Z1 with Plate

An Arca-Swiss quick release compatible system may be coupled magnetically to a mobile camera-enabled device in accordance with an example embodiment. A telephoto lens or a wide angle lens or an anamorphic lens or an auxiliary lens and/or a lens filter may be coupled with Arca-Swiss quick release system capability.

An Arca-Swiss plates may be coupled with a mobile camera-enabled device using a magnetic coupling in accordance with example embodiments. Then an auxiliary lens may be coupled to the Arca Swiss plate in stable alignment with the optical path of the miniature camera module of the mobile device. Certain other components may include a camera base plate, an L-bracket, modular brackets, lens feet and collars, gimbal heads including handheld and drone camera gimbal heads, and/or clamps.

The Arca-Swiss quick release system may be based on a two-piece mechanism, including a plate and a clamp. The plate may magnetically mount in accordance with an example embodiment to a camera-enabled mobile device such as an iphone, ipod, ipad, android, Samsung or other smart device. The clamp may serve as a mounting base for the Arca-Swiss quick release system. The plate may get attached and secured, for example, and may resides on the top of a tripod head. The clamp can be fully opened, allowing the plate to be dropped in and secured, or can be partially opened to allow the plate to be slid into the position. This allows for quick release capability. An example embodiment is configured with the ability to slide the plate without having to worry about mounting or dismounting anything. The plate may include a 45° dovetail which may allow equipment to be moved across the clamp and secured in a specific location using a side knob or a locking release.

### Magic Arm

In an example embodiment, a Pluto brand magic arm, with or without a clamp or other coupling feature, may be combined with a magnetic coupling in accordance with example embodiments. The magic arm may be shoe mounted. In one example, a ¼″-20 screw may be used.

The stability of a camera shooting setup may be improved with a magic arm that is magnetically-coupled to a mobile camera-enabled device. A bubble level or an electronic level may be used to precisely level the camera and/or the magic arm or accessory coupled thereto. The magic arm may be designed as an accessory for supporting equipment weighing one pound or less, or up to two or three or four pounds or more. The magic arm may magnetically couple to a mobile camera-enabled device in accordance with an example embodiment.

The magic arm may also couple to another accessory such as a light, a stand, a microphone, a speaker, a battery or other solar, wind or plug-in electrical power source, an input device such as keyboard, mouse, joystick, touchpad or touchscreen device. The other accessory may couple to the magic arm and thus to the camera-enabled mobile device using another magnetic coupling or an alligator clamp or a jaw clamp or a vice clamp, or a plier or a pair of high friction surfaces, such as rubber or soft plastic, may hold an accessory with applied pressure in a closed position and release the accessory in an open position, or a snap coupling or Velcro or single or double adhesive tape, or adhesive glue or putty, or a vice-grip, or a recess catch, or a micro-bayonet or a buckle, or cable straps, or a harness clip, or a quick release coupling.

The magic arm may be attached to a stand or tripod or quadipod or shelf or table. The magic arm may be body mounted such as to an arm or head or helmet or wrist or necklace. The magic arm may be coupled to another support upon which a camera may disposed. The magic arm may be directly coupled onto a mobile device, such as a camera or camera-enabled phone or smart device, or remote wireless controller. A removable shoe mount may be used that has a magnetic coupling or a screw coupling or a clamp or other coupling interface. The magic arm may be made of metal or polymeric components.

### Flexible Arm

An example embodiment may include a flexible arm that may be attached. In example embodiments, a flexible arm may include an action pod by Dinkum Systems, a Jobe griptite one gp stand, an Agfa photo 12″ tripod, or an Acubar 6.5″ flexible tripod. The flexible arm may be used as a quick-attaching mount to a mobile camera-enabled device or a light device or a flash device or a display device or a projector device. The flexible arm may be attached using a magnetic coupling in accordance with an example embodiment to a mobile camera-enabled device such as an iphone, ipod, ipad, android phone, Samsung phone, Google phone, Amazon device or a tablet. A flexible arm may be attachable using a magnetic coupling in accordance with an example embodiment. A clamping or magnetically coupled monopod may provide a stable base and the flexibility to mount any small device, e.g., with a ¼″-20 tripod thread.

The flexible arm may be mounted on most any magnetically susceptible surface such as a metal desk, office or home appliance, bike handle, car door, ski-pole, doorframe, tabletop, skateboard, computer case or computer stand or desk. The flexible arm may include a single multi-link, micro-adjustable arm for quickly finding the right position for a camera shot.

Other devices that the flexible arm may mount to by magnetic coupling in accordance with an example embodiment such as a GoPro, a Sony Action Cam, a point-and-shoot video camera, flash unit, radar detector, GPS unit, or an onboard light.

The magnetically-coupled flexible arm may serve the function of a tripod to stabilize a mobile camera device on a surface. The length of the flexible arm may be adjustable along with the orientation, tilt, or horizontal or vertical offset. A magnetically coupled accessory may replace conventionally mounted devices that use tripods, locking arms, adhesive bases, or suction mounts.

### Mobile Smart Device Cases with Embedded Magnet Arrays

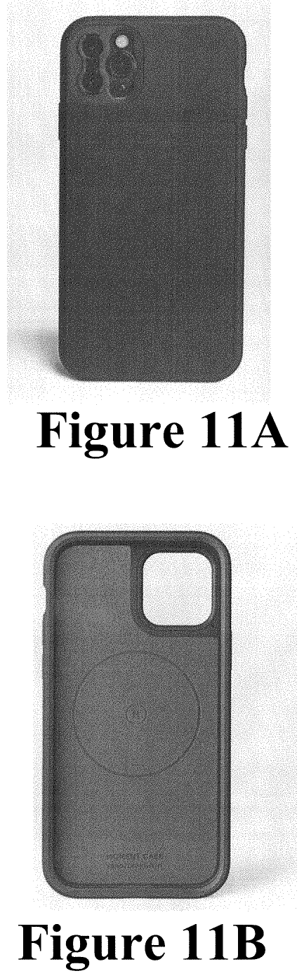

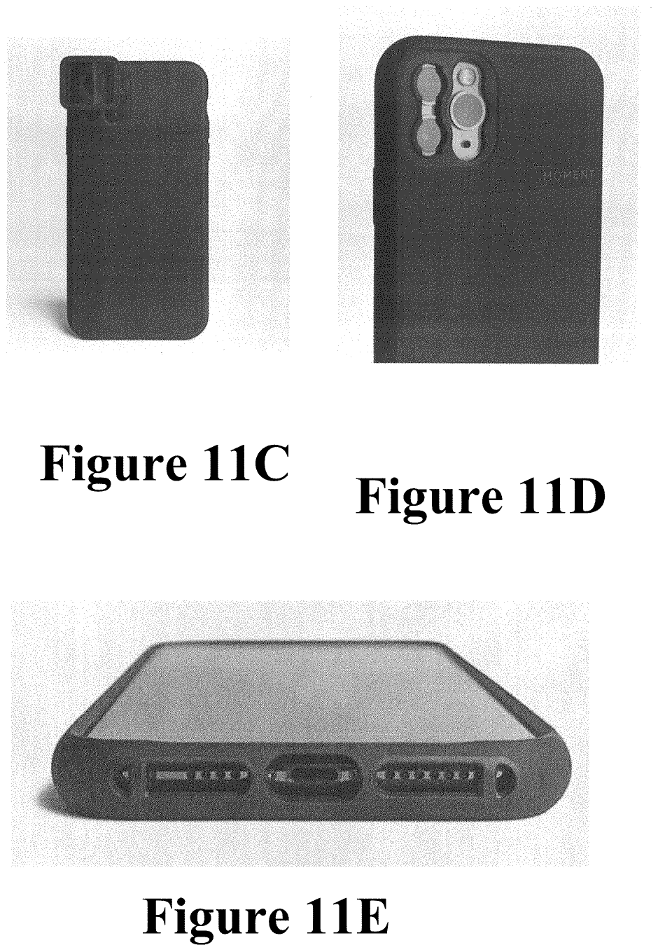

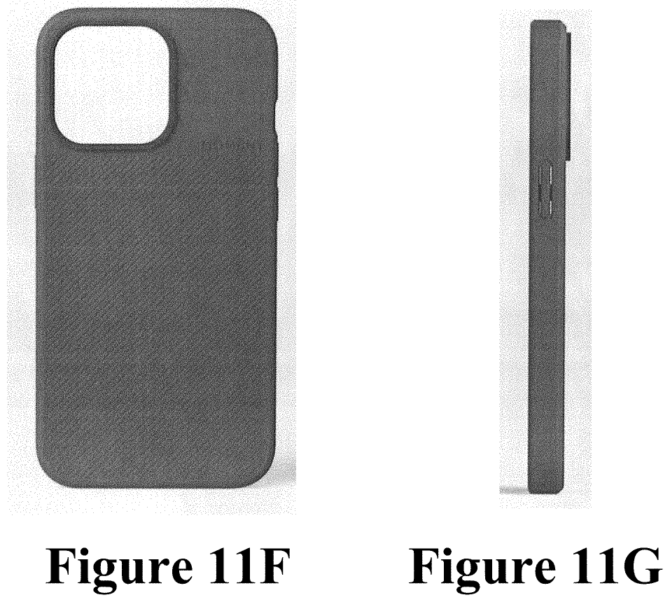

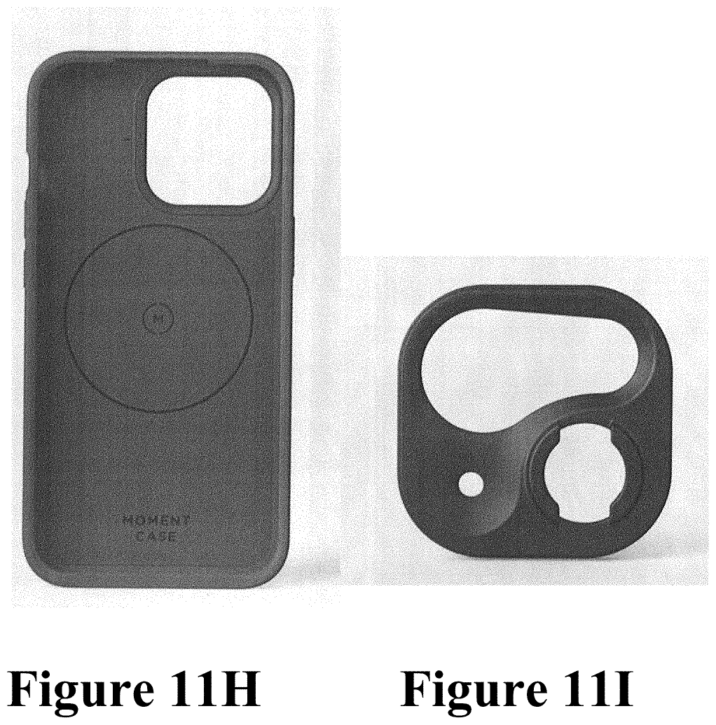

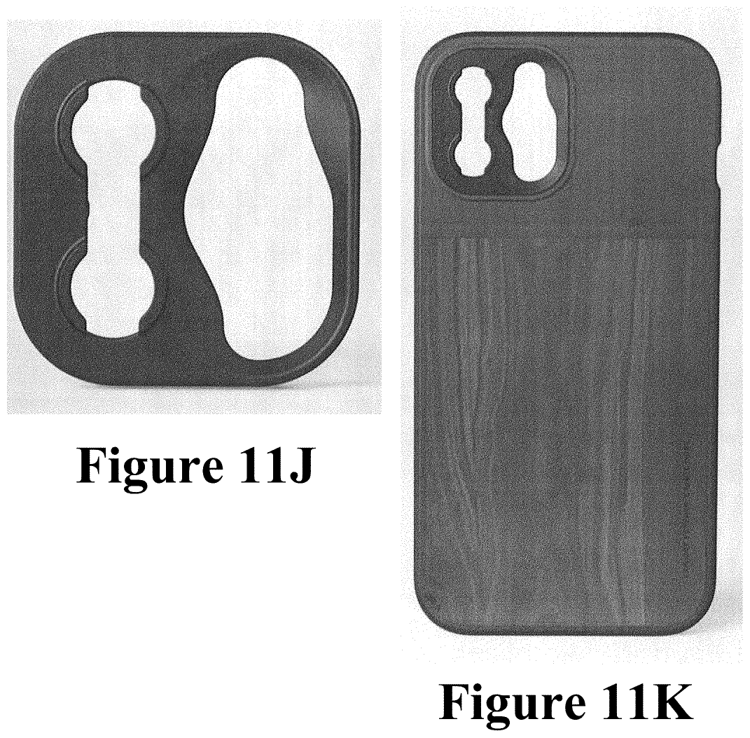

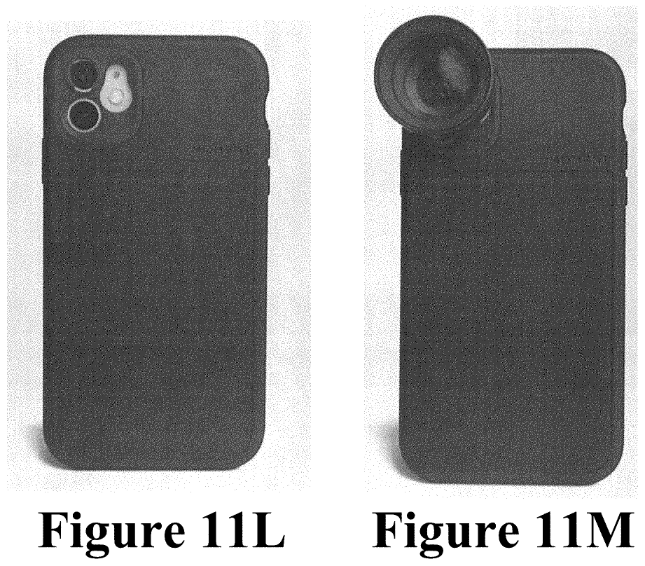

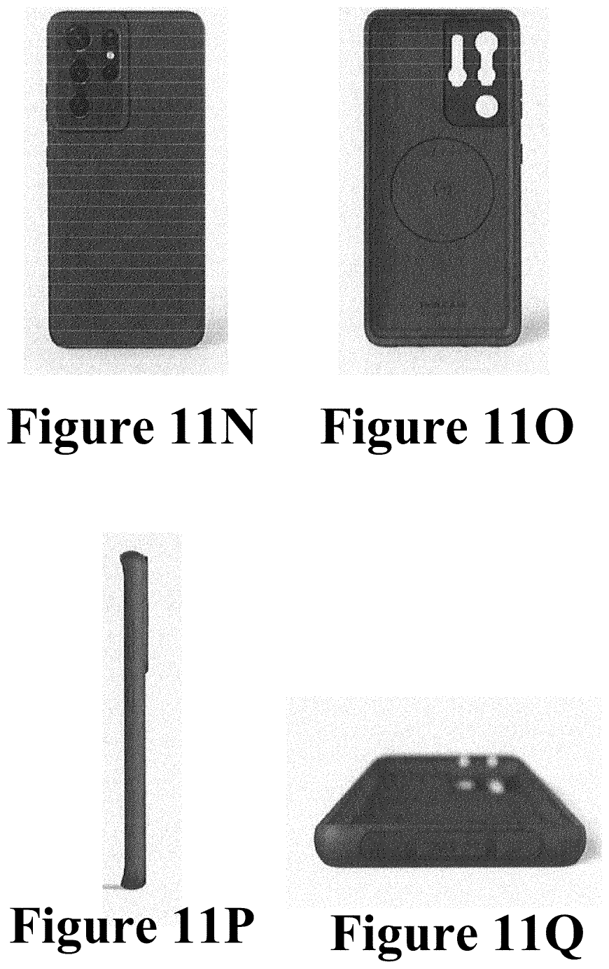

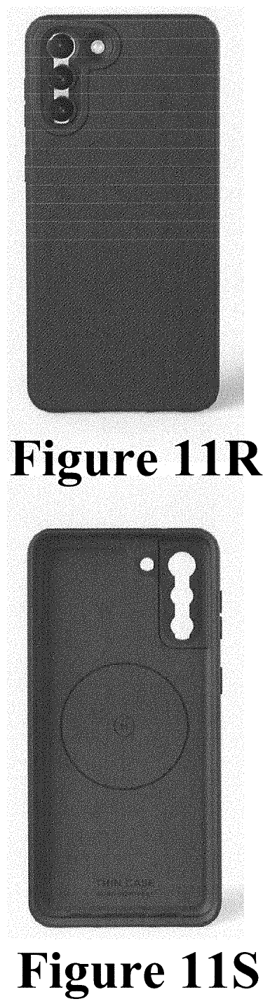

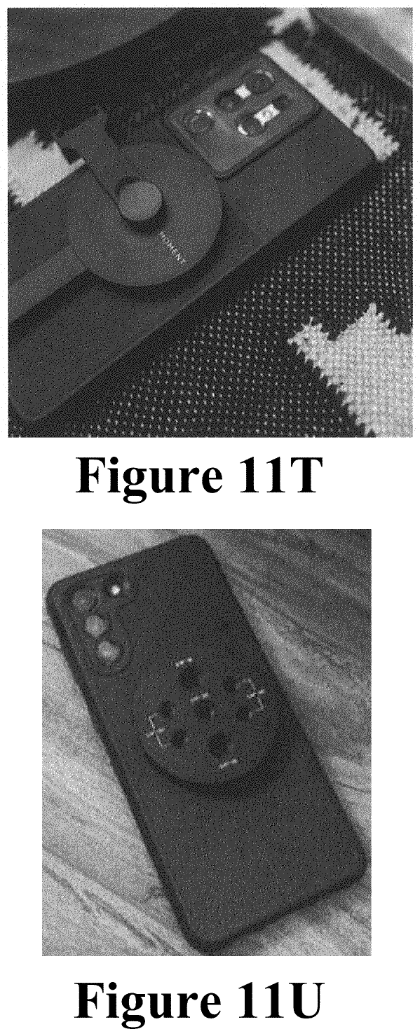

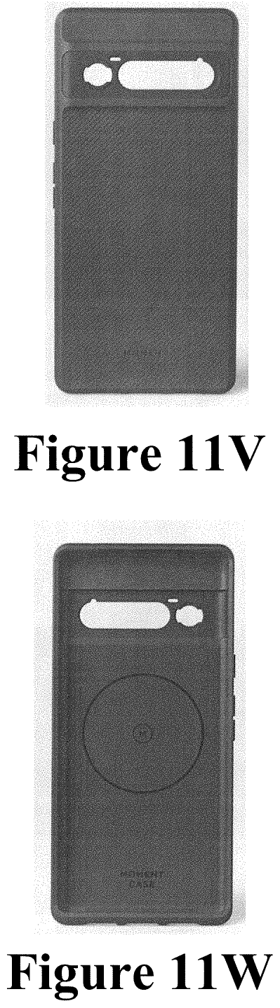

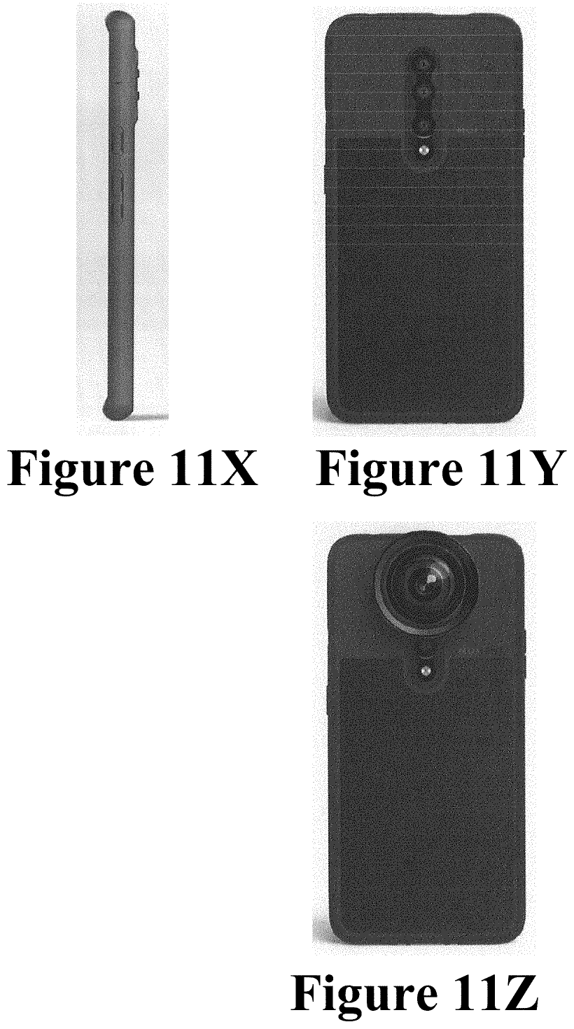

FIGS. 11A-11Z schematically illustrate example embodiments of mobile smart device cases, including cases for Apple smart devices including iphones 12 and 13 having Magsafe magnetic coupling capability and other Apple smart devices including earlier iphones that do not have Magsafe capability, such as iphones 7, 8, 9, X, 10, and 11 series smart devices, and cases for Samsung smart devices including Galaxy phones, and cases for Google smart devices including Pixel phones and Android phones, and cases for Oneplus smart devices, that are configured to magnetically couple with compatible mobile smart device accessories and accessory interface devices including microphones, lights, and tripod, cold shoe, gimbal, louvre, screw thread, or wall or other surface mounting capable accessories and accessory interface devices such as those shown and described with respect to the example embodiments of FIGS. 1A-10H.

A mobile camera system may include a camera-enabled, mobile device including a miniature camera module embedded within the mobile device that has a built-in lens and an image sensor for capturing digital images. A mobile device processor may be configured for processing the digital images, and a mobile device display may be configured for viewing the digital images. A mobile device case may be coupled around the camera-enabled mobile device. In several example embodiments, mobile device cases include magnet arrays embedded therein for magnetically coupling with accessories and/or accessory interface devices, which may couple with accessories mechanically such as by providing cold shoes, screw threads or unthreaded through holes for set screws, wood screws, drywall screws or nut and bolt attachments, louvre attachment interfaces, adhesives, bayonet coupling interfaces, compression buds, snap components or feedthrough receivers or combinations thereof. Accessory interface devices may also couple electrically, magnetically and/or wirelessly with an accessory.

A removable lens assembly may include a lens holder, a lens coupled to the lens holder, and a coupling interface. A lens attachment interface may be embedded within or integral with the case or coupled directly to the mobile device, and may be configured in accordance with the coupling interface of the removable lens assembly to stably couple and align the removable lens along the optical path of the miniature camera module.

The coupling interface of the removable lens assembly may include a magnet array embedded within the lens holder or a separate coupling interface which is itself coupled to the lens holder. The lens attachment interface which is embedded within or integral with the case or coupled directly to the mobile device may also include a magnet array. The magnet array coupling interface of the removable lens assembly and the magnet array lens attachment interface within the case or mobile smart device may provide reliable coupling of the removable lens in stable alignment along the optical path of the miniature camera module of the mobile smart device.

The coupling interface of the removable lens assembly may include a bayonet tab. The lens attachment interface may include a detent portion that at least partially defines a lens attachment cavity that is shaped in accordance with the bayonet tab of the removable lens assembly to stably couple and align the removable lens along the optical path of the miniature camera module of the mobile device.

The bayonet tab may have an oblong shape. The lens attachment interface may include a detent that defines an oblong cavity having a short dimension that is smaller than the long dimension of the bayonet tab such that the oblong cavity is penetrable by the bayonet tab at a first relative orientation while the bayonet tab stably couples within the oblong cavity in a second relative orientation. The bayonet tab may have a rectangular shape. The lens attachment interface may define a circular cavity in a first plane while the detent overlaps the circular cavity in a second plane that is spaced-apart from the first plane along the optical path.

The lens attachment cavity may include a lens attachment portion and a flash portion adjacent to a lens attachment portion to permit light from a mobile device flash to illuminate an object to be imaged. The lens attachment portion of the lens attachment cavity may be defined in a first plane that is spaced further from an image sensor of the miniature camera module than a second plane within which the flash portion of the lens attachment cavity is defined.

The case may define a camera cavity around the optical path of the miniature camera module that accommodates the coupling of the removable lens at the lens attachment interface. The camera cavity may also be shaped, at a flash portion adjacent to a lens attachment portion, to permit light from a mobile device flash to illuminate an object to be imaged.

The lens holder of the removable lens assembly may define a cavity around the optical path of the miniature camera module to permit light from an object being imaged to reach an image sensor of the miniature camera module. The coupling interface of the removable lens assembly also may define a cavity around the optical path of the miniature camera module to permit light from an object being imaged to reach an image sensor of the miniature camera module. The cavities of the coupling interface and lens holder may be approximately coaxial with the optical paths of the miniature camera module and removable lens.

A mobile device case may be configured for coupling around a mobile smart device that includes a miniature camera module. A case housing may be configured to securely couple around at least a portion of the periphery of the camera-enabled mobile device. The case may be configured to define therein a display aperture and a camera aperture. A lens attachment interface may be provided that is shaped both to permit light from an object to be captured as a digital image to travel along the optical path of the miniature camera module to a built-in image sensor of the miniature camera module of the mobile device, and to facilitate stable coupling of a removable lens in optical alignment with the miniature camera module.

The lens attachment interface may be embedded within or integral with the case or may be coupled directly to the mobile device, and may be configured in accordance with a coupling interface of a removable lens assembly to stably couple and align the removable lens assembly along the optical path of the miniature camera module. One or both of the coupling interface of the removable lens assembly and the lens attachment interface may include a magnet array for magnetic coupling of the removable lens in stable alignment with the miniature camera module of the mobile device, or a bayonet coupling interface may be used, or otherwise in accordance with any of several embodiments described herein.

Another auxiliary optical assembly is provided herein for a mobile device that includes a miniature camera module. A removable lens assembly of the auxiliary optical assembly includes a lens holder, a lens coupled to the lens holder, and a coupling interface. A lens attachment interface of the auxiliary optical assembly is configured in accordance with the mobile device to stably couple to the mobile device, and in accordance with the coupling interface of the removable lens assembly to stably couple and align the removable lens along the optical path of the miniature camera module.

The lens attachment interface may be configured for snap coupling, drop coupling, shape coupling, compression coupling, and/or adhesive coupling within the camera aperture of the case and automatically aligned with the miniature camera module of the mobile device. The lens attachment interface may be shaped in accordance with a shape of the components of the miniature camera module of the mobile device. The lens attachment interface may also be sized in accordance with sizes of the components of the miniature camera module of the mobile device. The lens attachment interface may define one or more apertures that are coaxially configured in accordance with one or more optical paths of components of a miniature camera module of the mobile device.

In example embodiments, the coupling interface of the removable lens assembly may include a magnet array embedded within the lens holder or a separate coupling interface which is itself coupled to the lens holder. The lens attachment interface which is embedded within or integral with the case or coupled within the camera aperture of the case or coupled directly to the mobile device may also include a magnet array. The coupling together of the magnet array coupling interface of the removable lens assembly and the magnet array lens attachment interface within the case or mobile smart device may provide reliable coupling of the removable lens in stable alignment along the optical path of the miniature camera module of the mobile smart device.

In example embodiments, a magnet array is embedded within a mobile smart device case in the shape of the camera aperture of the case or in the shape of one of multiple apertures formed within a lens attachment interface that is coupled to or integral with the case. A compatible magnet array is also embedded within an auxiliary lens coupling interface in an example embodiment that is configured for magnetic coupling with a magnet array defining or surrounding a case camera aperture or with a magnet array defining an aperture defined within a lens attachment interface.

In alternative example embodiments, a single magnet array may be embedded either within a removable lens coupling interface or within a lens attachment interface within the case or mobile device. The single ferromagnet or ferrimagnet array may couple in these alternative example embodiments to paramagnetic material provided within the other interface that does not contain a ferromagnetic or ferrimagnetic array.

In alternative example embodiments, ferrite magnets may be used to form all of part of a magnet array that is embedded within a mobile smart device case, accessory and/or accessory interface device. A mobile smart device may include a magnet array formed in whole or in part by ferrite magnets and/or by ferromagnets. In certain example embodiments, hard ferrite magnets such as Barium hexaferrite and/or Strontium hexaferrite may be used to form all or part of a ferrimagnetic array.

The coupling interface of the removable lens assembly may include a bayonet tab. The lens attachment interface may include a detent portion that at least partially defines a lens attachment cavity that is shaped in accordance with the bayonet tab of the removable lens assembly to stably couple and align the removable lens along the optical path of the miniature camera module of the mobile device. The bayonet tab may be configured with an oblong and/or curved shape in accordance with any of several removable lens embodiments and lens attachment interface embodiments described herein. A case may be configured in accordance with the coupling interfaces of the removable lens and lens attachment interface as described in various embodiments herein.

While an exemplary drawings and specific embodiments of the present invention have been described and illustrated, it is to be understood that that the scope of the present invention is not to be limited to the particular embodiments discussed. Thus, the embodiments shall be regarded as illustrative rather than restrictive, and it should be understood that variations may be made in those embodiments by workers skilled in the arts without departing from the scope of the present invention.

In addition, in methods that may be performed according to preferred embodiments herein and that may have been described above, the operations have been described in selected typographical sequences. However, the sequences have been selected and so ordered for typographical convenience and are not intended to imply any particular order for performing the operations, except for those where a particular order may be expressly set forth or where those of ordinary skill in the art may deem a particular order to be necessary.

A group of items linked with the conjunction “and” in the above specification should not be read as requiring that each and every one of those items be present in the grouping in accordance with all embodiments of that grouping, as various embodiments will have one or more of those elements replaced with one or more others. Furthermore, although items, elements or components of the invention may be described or claimed in the singular, the plural is contemplated to be within the scope thereof unless limitation to the singular is explicitly stated or clearly understood as necessary by those of ordinary skill in the art.

The presence of broadening words and phrases such as “one or more,” “at least,” “but not limited to” or other such as phrases in some instances shall not be read to mean that the narrower case is intended or required in instances where such broadening phrases may be absent. The use of the terms “system” or “assembly” does not imply that the components or functionality described or claimed as part of the assembly are all configured in a common package. Indeed, any or all of the various components of a system, e.g., a case and a lens attachment interface may be combined in a single package or separately maintained and may further be manufactured, assembled or distributed at or through multiple locations.

In addition, all references cited above and below herein, as well as the background, invention summary, abstract and brief description of the drawings, are all incorporated by reference into the detailed description of the preferred embodiments as disclosing alternative embodiments. Several embodiments of mobile smart devices, mobile smart device cases, mobile smart device accessories, mobile smart device accessory coupling types and components, and mobile smart device accessory coupling interface devices have been described herein and schematically illustrated by way of example physical, magnetic, electronic and/or optical architectures. Other embodiments and embodiments of features and components that may be included within alternative embodiments, may be described at one or a combination of U.S. Pat. Nos. 7,612,997, 8,244,299, 8,593,745, 8,843,177, US published patent applications nos. 2006/0124676, 2012/0282977, 2014/0071547, 2014/0226268, 2014/0071547, 2013/0063554, 2010/0253826, 2009/0299813, 2002/0000689, 2001/0121116, 2009/0089842, 2008/0276293, 2008/0271105, 2008/0271104, 2008/0172708 and/or European patent no. EP2613448.

What is claimed is:

1. A mobile smart device accessory coupling interface, comprising:
a. a mobile smart device case, comprising:
i. a mobile smart device case housing that is configured to enclose a mobile smart device and define camera and touchscreen display apertures;
ii. a mobile smart device case magnet array embedded within the mobile smart device case housing that is configured for magnetically coupling with a mobile smart device accessory interface device;
b. a mobile smart device accessory interface device, comprising:
i. a mobile smart device accessory interface device housing;
ii. a mobile smart device accessory interface device magnet array embedded within or attached at or near a surface of the mobile smart device accessory interface device housing that is configured for magnetically coupling with the mobile smart device case magnet array;
iii. an accessory coupling interface coupled to or integral with the mobile smart device accessory interface device housing that is configured for coupling with a mobile smart device accessory or with a second mobile smart device accessory interface device or both.

2. The mobile smart device accessory coupling interface of claim 1, comprising the mobile smart device case enclosing the mobile smart device magnetically coupled with the mobile smart device accessory interface device.

3. The mobile smart device accessory coupling interface of claim 2, wherein the mobile smart device accessory coupling interface is configured for mechanically coupling with a coupling interface of a mobile smart device accessory, to thereby couple the mobile smart device accessory with the mobile smart device.

4. The mobile smart device accessory coupling interface of claim 1, wherein the accessory coupling interface comprises a tripod mount interface.

5. The mobile smart device accessory coupling interface of claim 4, wherein the tripod mount interface comprises a tripod mount arm connected at one end to a puck containing said accessory interface magnet array and having a tripod connector at the other end.

6. The mobile smart device accessory coupling interface of claim 5, wherein the tripod mount arm is sufficiently long to permit both portrait and landscape orientations of the mobile smart device case without the tripod accessory getting in the way.

7. The mobile smart device accessory coupling interface of claim 4, wherein the accessory coupling interface is rotatable relative to an orientation of the mobile smart device case.

8. The mobile smart device accessory coupling interface of claim 4, wherein the accessory coupling interface includes a rotatable coupling component that permits rotation of a mobile smart device accessory relative to the mobile smart device case.

9. The mobile smart device accessory coupling interface of claim 1, wherein the accessory coupling interface comprises both a cold shoe mount interface and a tripod mount interface.

10. The mobile smart device accessory coupling interface of claim 1, wherein the accessory coupling interface comprises a cold shoe mount interface.

11. The mobile smart device accessory coupling interface of claim 1, wherein the accessory coupling interface comprises a wall mount interface.

12. The mobile smart device accessory coupling interface of claim 11, wherein the wall mount interface is configured for coupling adhesively to a wall or other flat surface.

13. The mobile smart device accessory coupling interface of claim 11, wherein the wall mount interface comprises a through hole for coupling the wall mount interface to a wall or other flat surface using a set screw, a wood screw, a drywall screw, a nail or a nut and a bolt.

14. The mobile smart device accessory coupling interface of claim 1, wherein the accessory coupling interface comprises a louvre mount interface configured for securely coupling with automobile air conditioning system air flow control vent louvres.

15. The mobile smart device accessory coupling interface of claim 1, wherein the accessory coupling interface comprises a screw threaded mount interface.

16. The mobile smart device accessory coupling interface of claim 1, wherein the accessory coupling interface is configured for coupling a magic arm, a flexible arm or an otherwise rotationally or translationally adjustable arm, gimbal, extender, selfie stick or another mobile smart device position or orientation adjustment assistance tool.

17. The mobile smart device accessory coupling interface of claim 1, wherein the accessory coupling interface comprises a lavallier microphone coupling interface.

18. The mobile smart device accessory coupling interface of claim 1, wherein the accessory coupling interface comprises a ring light mount interface.

19. The mobile smart device accessory coupling interface of claim 1, wherein the accessory coupling interface comprises a magnetic lens coupling and alignment interface configured for magnetically an auxiliary lens in stable alignment along an optical path of a miniature camera module of the mobile smart device.

20. The mobile smart device accessory coupling interface of claim 19, wherein the magnetic lens coupling and alignment interface comprises a magnet array that is compatible for magnetic coupling with a magnet array that is embedded within an auxiliary lens holder or lens coupling interface that is itself coupled with or integrated within the auxiliary lens holder or another auxiliary lens handling or packaging component.
